(19) United States
(12) Patent Application Publication
(10) Pub. No.: US 2026/0114465 A1
(43) Pub. Date: Apr. 30, 2026

(54) NOVEL METHOD OF PRODUCING BUTTER-LIKE PRODUCTS AND THE OBTAINABLE BUTTER-LIKE PRODUCTS

(71) Applicant: ARLA FOODS AMBA, Viby J (DK)

(72) Inventors: Shyam Krishna SUWAL, Viby J (DK); Ulf ANDERSEN, Viby J (DK); Laura Marloth TIMM, Viby J (DK); Frederik Tage JOHANSEN, Viby J (DK)

(21) Appl. No.: 19/116,171

(22) PCT Filed: Sep. 28, 2023
(86) PCT No.: PCT/EP2023/076842

§ 371 Date: Mar. 27, 2025

(30) Foreign Application Priority Data
Sep. 28, 2022 (EP) 22198455.2

(51) Int. Cl. A23C 15/02; A23C 15/12

(52) U.S. Cl. CPC A23C 15/02; A23C 15/12; A23C 2260/10

(57) ABSTRACT

The present invention pertains to a new method of producing butter-like products based on warm shearing of liquid, high fat concentrates of milk fat globules, which liquid concentrates contain a significant amount of micellar casein. The invention furthermore pertains to the novel butter-like products as such and uses of the novel butter-like products.

### FIELD OF THE INVENTION

The present invention pertains to a new method of producing butter-like products based on warm shearing of high fat concentrates of milk fat globules that contain a significant amount of micellar casein. The invention furthermore pertains to the novel butter-like products as such.

### BACKGROUND

Conventional butter production is based on cold churning of cream that has aged (stored at a temperature below 20 degrees C.) to provoke partial crystallisation of milk fat in the milk fat globules. The churning process disrupts the membranes of the milk fat globules of the cream and causes the milk fat to aggregate to form larger fat grains which can be separated from the buttermilk.

US 2019/0191731 A1 discloses a method of modification of dry matter composition and/or dry matter content of milk, comprising the steps of:
providing raw milk having a fat content in the range of about 3% w/w to about 60% w/w;
modifying, e.g. by microfiltration, a dry matter composition and/or dry matter content of the raw milk to provide a modified raw milk having:
   a fat content in the range of about 35% w/w to about 60% w/w based on the total weight of the modified raw milk, and
   a protein content of at most 3% w/w and/or carbohydrate content of at most 4% w/w based on a fat-free portion of the modified raw milk.

WO 89/10700 discloses the production of a fat product based on milk fat where the cream is concentrated by centrifugation to a fat content of 60-85% at a temperature of 50-70 degrees C. The concentrated cream is cooled to a temperature of 15-30 degrees C., and is stored until the milk fat starts to crystallize. The cooled concentrated cream is mixed with vegetable oils in an amount calculated to at least 25% of the amount of fat in the end product. After storage the mixture is stirred gently under cooling in order to achieve a phase reversal.

US 2003/0175399 A1 discloses dairy products having a total fats content lower than or equal to 400 g/kg and a fat globule distribution such that globules of lower diameter than 2.0 microns represent 10% to 60% in weight of the total fats, and the fat globules of higher diameter than to 6 micron represent 10% to 30% in weight of the total fats. The dairy products were produced by microfiltration of milk or mixtures of milk and cream.

WO 2012/110706 discloses a method for producing cheese, comprising the steps of:
providing a milk raw material,
subjecting the milk raw material to microfiltration and pre-acidification to produce an acidified casein concentrate, where the microfiltration is performed prior to or simultaneously with the pre-acidification,
concentrating the acidified casein concentrate to produce full concentrated pre-cheese,
processing the full concentrated pre-cheese to a cheese product.

Goudedranche et al (Le Lait, INRA Editions, 2000, 80 (1), pp. 93-98.) discloses separation of milk fat in small globules (SG) (diameter lower than 2 μm) and in large globules (LG) (diameter higher than 2 μm) using special ceramic microfiltration membranes. Transformations in drinking milks, yoghourts, sour cream, camembert, Swiss cheese and butters were realized from milks of which the fat content was adjusted either by reference cream or by creams issued from the SG or the LG fractions. Significant differences in texture and organoleptic properties were found in the manufactured products. Except for butter, use of milks containing small fat globules led to more onctuous products and finer textural characteristics versus products made with reference creams or with mainly large fat globules. Fat globule membrane appeared to have a high ability to bind water in cheese and so, to allow a significant increase in cheese yield.

FR 588993 discloses a method of producing a butter oil-based product with an appearance similar to butter and uses butter oil, water and milk powder as starting materials. The starting materials are mixed to prepare a butter oil emulsion during heating. The final product of FR 588993 is prepared by cooling the butter oil emulsion to a temperature of 13-19 degrees C. and subjecting the cooled emulsion to squeezing or crushing.

Jukkola (Jukkola et al, “Effect of heat treatment and pH on the efficiency of micro-diafiltration for the separation of native fat globules from cream in butter production”, Journal of Membrane Science Volume 548, 15 Feb. 2018, Pages 99-107) discloses a method of preparing protein-reduced cream by microfiltration/diafiltration and the authors of Jukkola used these protein-reduced creams for conventional production of butter. The fat content of the creams was approx. 41% and the butter-making involved traditional cold aging and cold churning of the creams.

### SUMMARY OF THE INVENTION

The present inventors have discovered that a new type of butter-like milk product can be prepared by warm shearing of liquids having a high content of milk fat globules and a significant content of micellar casein relative to the total water content. The new method allows for the production of butter-like products without formation of a sidestream such as buttermilk and is furthermore much faster and requires less energy than the traditional butter-making processes.

Thus, an aspect of the invention pertains to a method of producing a butter-like product, the method comprising the steps of:
a) providing a liquid, milk fat globule composition (lmc), preferably having a temperature in the range of 20-65 degrees C.,
the lmc comprising:
   i) milk fat globules (MFG) in an amount of at least 50% w/w of the lmc,
   ii) at least 1.5% w/w micellar casein relative to the weight of the water content of the lmc,
   iii) water, and
   iv) optionally, one or more additional component(s),
b) optionally, subjecting the lmc to a heat-treatment in which the lmc is heated to a temperature of at least 66 degrees C.,
c) subjecting the lmc obtained from step a) or b) to a shearing step, and wherein the temperature of the lmc during the shearing step is in the range of 25-100 degrees C., thereby obtaining a milk fat intermediate,
d) optionally, combining the milk fat intermediate and one or more further ingredient(s), thereby obtaining a mixture, and
e) optionally, packaging the milk fat intermediate obtained from step c) or the mixture obtained from step d),
and wherein the butter-like product preferably is the milk fat intermediate obtained from step c), the mixture obtained from step d), or the packaged product obtained from step e).

Another aspect of the invention pertains to the butter-like product obtainable by the present method.

The butter-like product of the invention has a better texture and spreadability and less brittle-ness than a conventional butter-like products with a similar fat content.

The butter-like product preferably comprises:
total fat in an amount in the range of 50-85% w/w, and preferably in the range of 60-85% w/w,
water in an amount in the range of 10-48% w/w, and preferably in the range of 10-39% w/w
total protein in an amount in the range of 0-5% w/w,
and the butter-like product preferably has a pH in the range of 4.5-8.

Yet an aspect of the invention pertains to the use of the butter-like product as an ingredient in the production of a food product.

### SUMMARY OF THE FIGURES

FIG. 1 shows confocal micrograph images of the products obtained by subjecting samples of the same lmc to homogenization using different pressures as described in Example 1.

FIG. 2 shows firmness of the homogenised samples of Example 1.

FIG. 3 shows photographs of butter-like spreadable products produced by Example 1 at different pressure.

FIG. 4 shows confocal micrograph images of butter-like products produced by microfiltration/diafiltration of cream and subsequent homogenization at different pressures as described in Example 2.

FIG. 5 shows the firmness of butter-like products produced in Example 2.

FIG. 6 shows confocal micrograph images of the products obtained by subjecting samples of the same lmc (produced by microfiltration/diafiltration of cream treated with sodium citrate to dissolve the casein micelles) to different homogenization pressure as described in Example 3.

FIG. 7 shows the firmness of products produced in Example 3.

FIG. 8 shows confocal micrographs images of the products produced by homogenization of concentrated cream prepared by microfiltration and diafiltration of washed (protein-reduced) cream as described in Example 4.

FIG. 9 shows confocal micrographs images of the products produced by homogenization of concentrated cream enriched with whey protein as described in Example 4.

FIG. 10 shows confocal micrographs images of the products produced by homogenization of concentrated cream enriched with sodium caseinate as described in Example 4.

FIG. 11 shows the firmness of the products of Example 4 and the effect of adding whey protein or caseinate to a concentrated cream having a low content of micellar casein.

### DETAILED DESCRIPTION

An aspect of the invention pertains to a method of producing a butter-like product, the method comprising the steps of:
a) providing a liquid, milk fat globule composition (lmc), preferably having a temperature in the range of 20-65 degrees C., the lmc comprising:
   i) milk fat globules (MFG) in an amount of at least 50% w/w,
   ii) at least 1.5% w/w micellar casein relative to the weight of the water content of the lmc,
   iii) water, and
   iv) optionally, one or more additional component(s),
b) optionally, but preferably, subjecting the lmc to a heat-treatment in which the lmc is heated to a temperature of at least 66 degrees C.,
c) subjecting the lmc obtained from step a) or b) to a shearing step, and wherein the temperature of the lmc during the shearing step is in the range of 25-100 degrees C., thereby obtaining a milk fat intermediate,
d) optionally, combining the milk fat intermediate and one or more further ingredient(s), thereby obtaining a mixture, and
e) optionally, packaging the milk fat intermediate obtained from step c) or the mixture obtained from step d),
and wherein the butter-like product preferably is the milk fat intermediate obtained from step c), the mixture obtained from step d), or the packaged product obtained from step e).

In the context of the present invention the term “butter-like product” pertains to the product obtained by the method. The butter-like product has the visual appearance and texture similar to regular butter or spreads prepared by blending butter and vegetable oil, and preferably also similar sensory characteristics. Similar to regular butter, the butter-like product is solid or semi-solid at 5 degrees C. but becomes softer when heated to room temperature. The butter-like product typically contains at least 50% w/w fat relative to its total weight and at least 50% w/w milk fat relative to the total amount of fat.

The butter-like product may be the milk fat intermediate as such obtained from step c) if the method does not contain step d) in which one or more further ingredients are added, or alternatively the butter-like product may be the product resulting from step d), or even the pack-ages product obtained from step e).

In the context of the present invention the term “milk fat globules” or “MFG” pertains to milk fat globules that originate from mammal milk and that have preferably been concentrated or separated with no or only limited membrane damage during processing.

The milk and the MFG sources of the present invention preferably originate from one or more ruminant species, and preferably from milk from one or more of cow, sheep, goat, buffalo, camel, llama, mare and/or deer. It is particularly preferred that the milk and the MFG sources of the present invention originate from cow milk.

The content of MFG in a lmc can be determined by washing out the non-MFG matter (e.g. by dilution of a sample of lmc in demineralized water, and sequential separation of MFG by gentle centrifugation and re-dilution of the separated MFG in demineralized water) and determining the total solids of the washed MFG preparation.

In the context of the present invention the term “liquid, milk fat globule composition” (abbreviated “lmc”) refers to the liquid that is subjected to the shearing of step c), optionally after having been subjected to the heat-treatment of step b). The lmc has a high content of MFG which typically makes up at least 50% w/w of the total weight of the lmc. The lmc may furthermore contain other fat sources than MFG but the MFG are the primary source of fat of the lmc. Additionally, the lmc comprises water and micellar casein and optionally one or more additional components. The one or more additional components of the lmc typically include minerals, carbohydrate, whey proteins, and small organic molecules.

In the context of the present invention the term “micellar casein” pertains to casein in form of micelle-like structures comprising the different casein species as well as minerals such as calcium and phosphate. Casein micelles are found in and may be isolated from milk, e.g. by ultra-centrifugation or microfiltration, typically using microfiltration membrane having a pore size that retains casein micelles but allows for the passage of whey protein. The amount of micellar casein is typically determined by separation of the casein micelles in a diluted sample by ultra-centrifugation, preferably by initial equilibration at 30 degrees C. for 1 hour and centrifugation at 100,000 g for 1 hour at the same temperature, and subsequent quantification of the amount separated caseins by HPLC, preferably as outlined in Bobe et al (Separation and Quantification of Bovine Milk Proteins by Reversed-Phase High-Performance Liquid Chromatography; Bobe et al; J. Agric. Food Chem. 1998, 46, 458-463).

In the context of the present invention the term “milk fat intermediate” refers to the sheared lmc obtained from step c).

In step a) of the method the liquid, milk fat globule composition (lmc) is provided.

The lmc comprises one or more MFG source(s) in an amount sufficient to contribute with at least 50% w/w MFG relative to the weight of the lmc, and optionally comprises one or more additional ingredient(s).

The provision of the lmc typically comprises providing one or more MFG source(s) and optionally mixing the one or more MFG source(s) with one or more additional ingredients.

More specifically, the lmc is typically prepared by one of the following:
providing a single MFG source which will be the lmc,
mixing two or more MFG sources.
mixing a single MFG source with one or more additional ingredient(s), or
mixing two or more MFG sources with one or more additional ingredient(s).

In the context of the present invention the term “MFG source” pertains to an ingredient that contains MFG. It is particularly preferred that lmc is prepared using at least one MFG source that contains MFG in an amount of at least 50% w/w relative to the weight of the source, preferably prepared by microfiltration and/or centrifugation of milk, cream, or a mixture thereof.

Preferably, water makes up at least 75% w/w of the non-fat weight of a MFG source, and even more preferably water makes up in the range of 75-95% w/w of the non-fat weight of a MFG source.

In some preferred embodiments of the present invention, at least 50% w/w of the MFG of the lmc is provided by one or more MFG source(s) containing MFG in an amount of at least 50% w/w relative to the weight of the source, preferably prepared by microfiltration and/or centrifugation of milk, cream, or a mixture thereof.

In other preferred embodiments of the present invention, at least 50% w/w of the MFG of the lmc is provided by one or more MFG source(s) containing MFG in an amount of at least 55% w/w relative to the weight of the source, preferably prepared by microfiltration and/or centrifugation of milk, cream, or a mixture thereof.

Often, at least 50% w/w, more preferably at least 60% w/w, even more preferably at least 80% w/w, and most preferably at least 90% w/w of the MFG of the lmc are provided by one or more MFG source(s) containing MFG in an amount in the range 50-75% w/w relative to the weight of the source.

In some preferred embodiments of the present invention, at least 50% w/w, more preferably at least 60% w/w, even more preferably at least 80% w/w, and most preferably at least 90% w/w of the MFG of the lmc are provided by one or more MFG source(s) containing MFG in an amount in the range 55-65% w/w relative to the weight of the source.

If mixing is required for the preparation of the lmc, the MFG source(s) and additional ingredient(s) are mixed in the amounts required to obtain the desired composition of the lmc, e.g. in relation to the content of MFG, total fat, total protein, micellar casein, water, and other components.

If used, the one or more additional ingredient(s) preferably comprise one or more of the following:
water
fermented milk product, preferably added in an amount in the range of 1-5% w/w relative to the weight of the mixture, more preferably 1.2-4%, and most preferably in the range of 1.5-3% w/w relative to the weight of the mixture,
sodium chloride, preferably added in an amount in the range of 0.1-4.5% w/w relative to the weight of the mixture, more preferably 0.5-3.0% w/w, and most preferably 0.8-1.5% w/w relative to the weight of the mixture,
a flavouring agent, preferably diacetyl,
a colouring agent,
a food acceptable preservative, preferably sodium sorbate,
a polysaccharide hydrocolloid,
a protein concentrate, preferably a whey protein concentrate, a concentrate of micellar casein, and/or a milk protein concentrate,
a fat source, preferably vegetable fat and/or butter,
a food acceptable antioxidant, and
a vitamin.

Preferred fat sources are vegetable fat and/or a source of milk fat. A useful source of milk fat, in addition the MFG source(s), is butter. In the present context the term “butter” pertains to dairy butter prepared by traditional churning of cream.

In the context of the present invention the term “vegetable fat” covers fat products of vegetable origin and encompasses both fat products that are liquid at room temperature and fat products that are solid or semi-solid at room temperature. The term “vegetable fat” also covers fat products prepared by processing of fat of vegetable origin, e.g. by fractionation, hydrogenation, refining processes, and/or interesterification.

The vegetable fat preferably comprises or even consists of one or more fats selected from the group of consisting of sunflower fat, corn fat, sesame fat, soya bean fat, palm fat, linseed fat, grape seed fat, rapeseed fat, coconut fat, olive fat, groundnut fat, and combinations thereof. Rapeseed fat is the presently preferred vegetable fat.

The term protein concentrate pertains to an ingredient that contains at least 30% w/w relative to total solids, and more preferably at least 70% w/w protein relative to total solids. A protein may be in the form of a powder or liquid. If in liquid form the solvent is typically water. Preferred protein concentrates are a whey protein concentrate, a concentrate of micellar casein, a milk protein concentrate, or a combination thereof.

The lmc is typically prepared by mixing one or more MFG source(s) with one or more additional ingredients, preferably in amounts sufficient to obtain the desired composition of the lmc, e.g. in relation to the content of MFG, total fat, total protein, micellar casein, water, and other components.

It is sometimes preferred that the one or more MFG source(s) have been pasteurized prior to the preparation of the lmc. As mentioned below it is also feasible to heat-treat the lmc when it has been prepared.

A preferred type of MFG sources are milk fat globule concentrates prepared by a process comprising the steps of:
1) providing a milk fat globule-containing dairy liquid (mfl) comprising total fat in an amount of 3-50% w/w,
2) subjecting the mfl to microfiltration (MF) to concentrate the mfl to a total fat content of at least 50% w/w, and if the mfl already contains 50% w/w fat the microfiltration concentrates the mfl to an even higher fat content.

The milk fat globule concentrates obtained from step 2) of the process may be used as such for preparing the lmc or may be heat-treated as described below prior to the preparation of the lmc.

In some preferred embodiments of the present invention at least 40% w/w, more preferably at least 60% w/w, even more preferably at least 80% w/w, and most preferably at least 90% w/w of the MFG of the lmc are provided by one or more MFG source(s) prepared by a process comprising the steps of:
1) providing a milk fat globule-containing dairy liquid (mfl) comprising total fat in an amount of 3-50% w/w,
2) subjecting the mfl to microfiltration (MF) to concentrate the mfl to a total fat content of at least 50% w/w, and if the mfl already contains 50% w/w fat the microfiltration concentrates the mfl to an even higher fat content.

In other preferred embodiments of the present invention the MFG of the lmc are provided by one or more MFG source(s) prepared by a process comprising the steps of:
1) providing a milk fat globule-containing dairy liquid (mfl) comprising total fat in an amount of 3-50% w/w,
2) subjecting the mfl to microfiltration (MF) to concentrate the mfl to a total fat content of at least 50% w/w, and if the mfl already contains 50% w/w fat the microfiltration concentrates the mfl to an even higher fat content.

In some preferred embodiments of the present invention the lmc is prepared by a process comprising the steps of:
1) providing a milk fat globule-containing dairy liquid (mfl) comprising total fat in an amount of 3-50% w/w,
2) subjecting the mfl to microfiltration (MF) to concentrate the mfl to a total fat content of at least 50% w/w, and if the mfl already contains 50% w/w fat the microfiltration concentrates the mfl to an even higher fat content.

In the context of the present invention the term “milk fat globule-containing dairy liquid” or “mfl” pertains to a dairy liquid derived from ruminant milk, and which contains milk fat globules from the original milk source. The milk fat globules of the mfl preferably resemble the milk fat globules of the original milk source and have preferably been concentrated with no or only limited membrane damage during processing. It is particularly preferred that most, if not substantially all, of the fat of the mfl is present in the form of milk fat globules.

The original milk source is preferably milk obtained from one or more ruminant species, and is preferably milk from one or more of cow, sheep, goat, buffalo, camel, llama, mare and/or deer. It is particularly preferred that the mfl is derived from cow milk.

Preferably, the fat of the mfl is milk fat and the proteins of the mfl are proteins found in milk.

In some preferred embodiments of the invention the mfl of step 1) comprises or even consists of raw milk, whole milk, milk-derived cream, or a mixture thereof.

Preferably the mfl is a cream having a total fat content in the range of 10-50% w/w, preferably prepared by concentrating milk fat globules from milk, preferably by centrifugation or alternatively by microfiltration.

The mfl of step 1) preferably has a pH in the range of 5.0-8, more preferably 5.5-8.0, even more preferably 6.0-7.5, and most preferably 6.4-7.0.

While a wide range of temperatures can be used, the inventors have found it advantageous that the mfl of step 1) has a temperature in the range of 40-70 degrees C., more preferably 45-70 degrees C., even more preferably 50-65 degrees C., and most preferably 55-60 degrees C.

The mfl of step 1) preferably comprises total protein in an amount in the range of 0.5-5% w/w, more preferably 1-4% w/w, even more preferably 1.5-3.5% w/w, and most preferably 1.5-3.0% w/w.

Alternatively, but also preferred, the mfl of step 1) may comprise total protein in an amount in the range of 0.5-5% w/w, more preferably 0.5-4% w/w, even more preferably 0.5-3% w/w, and most preferably 0.5-1% w/w.

In preferred embodiments of the invention the mfl of step 1) comprises total fat in an amount in the range of 5-50% w/w, more preferably 10-48% w/w, even more preferably 30-46% w/w, and most preferably 35-44% w/w.

The mfl of step 1) typically comprises carbohydrate in an amount in the range of 0-10% w/w, more preferably 0.1-8% w/w, even more preferably 0.5-6% w/w, and most preferably 1-5% w/w.

The mfl of step 1) typically has a weight ratio between total fat and total protein in the range of 5-50, more preferably 10-40, even more preferably 15-30, and most preferably 17-25.

It is particularly preferred that the preparation of the mfl has not involved size reduction of milk fat globules, e.g. by homogenisation and the inventors have seen indications that non-homogenised mfls perform better in the present invention than homogenised mfls and provide concentrates containing milk fat globules with less damaged globule membranes. It is therefore preferred that the mfl is a non-homogenised mfl. Milk fat globule concentrates based on non-homogenized mfl are also preferred for the preparation of the present butter-like product.

While not always necessary, it is often preferred that the mfl is heat-treated prior to step 2). Preferably, the mfl has been heat-treated at most 60 minutes prior to the microfiltration, more preferably at most 30 minutes prior to the microfiltration, even more preferred at most 10 minutes prior to the microfiltration and most preferably at most 5 minutes prior to the microfiltration.

The heat-treatment prior to the microfiltration preferably involves heating the mfl to a temperature of at least 70 degrees C. for a duration sufficient to obtain at least partial microbial reduction. The duration depends on the temperature and the desired level of microbial reduction. Preferably, the duration is sufficient to reduce content of colony forming units by at least 99%, more preferably by at least 99.9%, even more preferably by at least 99.99% and most preferably by at least 99.999%.

Useful heat-treatments are e.g. 70-80 degrees C. for 5-300 seconds.

Preferably, the heat-treatment prior to the microfiltration, if used, denatures at most 50% of the beta-lactoglobulin, more preferably at most 30% of the beta-lactoglobulin, even more preferably at most 25% of the beta-lactoglobulin, and most preferably at most 20% of the beta-lactoglobulin.

The heat-treatment prior to the microfiltration, if used, preferably denatures 1-50% of the beta-lactoglobulin, more preferably 2-30% of the beta-lactoglobulin, even more preferably 3-25% of the beta-lactoglobulin, and most preferably 4-20% of the beta-lactoglobulin.

After the heat-treatment the mfl is preferably cooled to the temperature desired for microfiltration.

Step 2) involves subjecting the mfl to microfiltration to concentrate the mfl to a total fat content of at least 50% w/w. The microfiltration preferably involves the use of a ceramic microfiltration membrane. The microfiltration is operated with one or more membranes that keep the fat globules in the retentate stream(s) and allows smaller components such as free whey proteins, lactose and minerals to enter the permeate stream(s).

The microfiltration of step 2) increases the content of fat on a weight percent basis relative to the fat content of the mfl. Therefore if the mfl already has a fat content of 50% w/w, the microfiltration of step 2) concentrates the mfl to a total fat content higher than 50% w/w.

The MF membrane may also be permeable to at least some of the casein micelles, typically the smaller of casein micelles. It is however preferred that a substantial amount of casein micelles are retained during the concentration.

Step 2) may be implemented as a batch process step, a semi-batch process step or a continuous process step. Implementation as a continuous process step is particularly preferred.

In some preferred embodiments of the invention, the microfiltration of step 2) furthermore involves diafiltration, preferably using a diluent in the form of water or an aqueous solution. Useful diluents are e.g. water, reverse osmosis permeate of milk or whey, nanofiltration permeate of milk or whey, and/or ultrafiltration permeate of milk or whey. The diluent is preferably essentially free of protein.

In other preferred embodiments of the invention, the microfiltration of step 2) does not involve diafiltration.

In some preferred embodiments of the invention, in step 2) the mfl is subjected to MF to concentrate the mfl to a total fat content of at least 52% w/w, more preferably at least 54% w/w, even more preferably at least 58% w/w.

The mfl is preferably concentrated to a total fat content of in the range of 60-85% w/w, more preferably 62-85% w/w, more preferably 65-85% w/w, even more preferably 70-85% w/w, and most preferably 72-82% w/w.

Alternatively, but also preferred, the mfl may e.g. be concentrated to a total fat content of in the range of 50-85% w/w, more preferably 52-85% w/w, even more preferably 54-85% w/w, and most preferably 56-82% w/w.

Concentration of the mfl to a total fat content of 50-70% w/w, more preferably 52-68% w/w, even more preferably 54-66% w/w, and most preferably 56-64% w/w is often advantageous if the milk fat globule concentrate subsequently is to be processed into a low fat, butter-like product.

In some preferred embodiments of the invention the mfl is concentrated to a total fat content of in the range of 70-85% w/w, more preferably 73-85% w/w, even more preferably 76-85% w/w, and most preferably 80-85% w/w.

Concentration of the mfl to a total fat content of 81-85% w/w, more preferably 81-85% w/w, even more preferably 82-85% w/w, and most preferably 82-84% w/w is advantageous if the milk fat globule concentrate subsequently is to be processed into a butter-like product, and particularly into butter as such.

The microfiltration membrane is preferably capable of retaining a substantial portion of the milk fat globules but permeable to native beta-lactoglobulin and preferably also other whey proteins. Often it is also preferred that the microfiltration membrane is permeable to at least the smallest casein micelles.

The inventors have found that it is advantageous to avoid membranes with too large pore sizes as these are blocked by milk fat globules during operation.

In some preferred embodiments of the invention the microfiltration membrane has a pore size in the range of 0.05-2 micron, more preferably 0.05-1.5, even more preferably 0.1-0.8, and most preferably 0.2-0.4 micron.

In other preferred embodiments of the invention the microfiltration membrane has a pore size in the range of 0.1-2 micron, more preferably 0.1-1.5, even more preferably 0.2-1.0, and most preferably 0.2-0.8 micron.

The inventors have found that for some applications it is beneficial to increase the weight ratio between casein and whey protein.

Preferred embodiments of the invention the step 2) is arranged and operated to provide a milk fat globule concentrate having a weight ratio between casein and whey protein of 80:20-99:1, more preferably 80:20-98:2, even more preferably 85:15-98:2, and most preferably 90:10-98:2.

In other preferred embodiments of the inventions, step 2) is arranged and operated to provide a milk fat globule concentrate having a weight ratio between casein and whey protein of 82:18-99:1, more preferably 82:18-98:2, even more preferably 83:17-98:2, and most preferably 90:10-98:2.

The microfiltration of step 2) preferably involves the use of a ceramic MF membrane. Preferably, the MF membranes used in step 2) are ceramic MF membranes.

In some preferred embodiments of the invention the microfiltration of step 2) involves the use of a ceramic membrane comprising or even consisting of metal oxide and/or metal carbide.

In other preferred embodiments of the invention the microfiltration of step 2) involves the use of a ceramic membrane comprising or even consisting of aluminium oxides, titanium oxides, zirconium oxides, or a combination thereof.

In further preferred embodiments of the invention the microfiltration of step 2) involves the use of a ceramic membrane comprising or even consisting of aluminium carbide, silicon carbide, or a combination thereof.

The inventors have found it advantageous that the MF membrane is a ceramic membrane comprising or even consisting of silicon carbide. Preferably, the MF membrane(s) used in step 2) are ceramic membrane(s) comprising or even consisting of silicon carbide.

The inventors have furthermore found it advantageous to use hydrophilic MF membranes and have seen indications that the use of hydrophilic MF membrane for preparing milk fat globule concentrates containing at least 60% fat, or even at least 50% w/w fat, provides less damage to the milk fat globules.

In some preferred embodiments of the invention the MF membrane has a contact angle against a droplet of distilled water at 20 degrees C. of at most 40 degrees, more preferably at most 30 degrees, even more preferably at most 20 degrees, and most preferably at most 15 degrees.

The microfiltration may for example employ monotube or multichannel configurations. Multichannel configuration is particularly preferred.

The microfiltration may be performed in a number of ways e.g. in batch, feed-batch or continuous mode and may involve only a single filter module or multitude of filter modules arranged in series and/or in parallel.

The inventors have found it advantageous to use the mfl at a temperature of at least 40 degrees C. in step 2) in order to avoid or at least reduce shear damage of the milk fat globules. Without being bound by theory, it is believed that the low content of solid fat in the milk fat globules at 40 degrees C. makes the fat globules more flexible and less likely to disrupt during the microfiltration.

The inventors have furthermore found it advantageous to limit or even avoid the exposure to protein denaturing temperatures during the microfiltration.

Preferably, the temperature of the mfl and MF retentate(s) derived from the mfl during the step 2) is in the range of 40-65 degrees C.; more preferably 45-65 degrees C., even more preferably 50-65 degrees C., and most preferably 50-60 degrees C.

In the context of the present invention the term “MF retentate(s)” pertain to both the final retentate resulting from the microfiltration operation of step 2) and to intermediate milk fat glob-ule-containing MF retentates which are present in some implementations of step 2), e.g. if diafiltration is used and/or if the microfiltration involves several MF units operates in series.

The inventors have seen indications that operating the microfiltration with a relatively low transmembrane pressure provides less shear and hence less damage on the milk fat globule membranes than microfiltration at very high transmembrane pressures.

In some preferred embodiments of the invention the microfiltration involves a transmembrane pressure in the range of 0.1-10 bar, more preferably 0.1-5 bar, more preferably 0.2-3 bar, even more preferably 0.3-1.0 bar, and most preferably 0.4-0.6 bar.

In other preferred embodiments of the invention the microfiltration involves a transmembrane pressure of at most 10 bar, more preferably at most 5 bar, more preferably at most 3 bar, even more preferably at most 1 bar, and most preferably at most 0.6 bar.

In further preferred embodiments of the invention the microfiltration involves a transmembrane pressure of at most 0.4 bar, more preferably at most 0.3 bar, even more preferably at most 0.2 bar, and most preferably at most 0.1 bar.

The microfiltration of step 2) is preferably arranged and operated to lose at most 2% w/w of the total fat of the mfl to the microfiltration permeate, more preferably at most 1.5% w/w, even more preferably at most 1.0% w/w, and most preferably at most 0.8% w/w.

In the context of the present invention the term “arranged and operated” means that the microfiltration is implemented and operated to fulfil the mentioned requirement. This means e.g. making an appropriate membrane selection and appropriate choices of operational parameters. Microfiltration as such is well-known to the skilled person and the skilled person is capable of making the appropriate selections and choices based on the guidance provided herein and his/her general technical knowledge.

In other preferred embodiments of the invention the microfiltration of step 2) is arranged and operated to lose at most 5% w/w of the total fat of the mfl to the microfiltration permeate, more preferably at most 3% w/w, even more preferably at most 1% w/w, and most preferably at most 0.5% w/w.

In further preferred embodiments of the invention the microfiltration of step 2) is arranged and operated to lose at most 45% w/w of the total phospholipid of the mfl to the microfiltration permeate, more preferably at most 30% w/w, even more preferably at most 20% w/w, and most preferably at most 16% w/w.

In some preferred embodiments of the invention the microfiltration of step 2) is arranged and operated to lose at most 10% w/w of the total phospholipid of the mfl to the microfiltration permeate, more preferably at most 6% w/w, even more preferably at most 4% w/w, and most preferably at most 2% w/w.

In the context of the present invention the term “microfiltration permeate” pertains to the permeate stream or combined permeate streams resulting from the microfiltration of step 2).

The inventors have observed that it often is beneficial to control the permeate flux during the microfiltration by applying a back-pressure at the permeate side of the MF membrane, e.g. using an appropriate valve. The back-pressure is preferably 0-5 bar and more preferably 0-3 bar. It is often preferred that the back-pressure at the permeate side of the MF membrane is lower than transmembrane pressure.

It may furthermore be preferred to subject the milk fat globule concentrate to a heat-treatment. The heat-treatment of the milk fat globule concentrate preferably involves heating the milk fat globule concentrate to a temperature of at least 70 degrees C. for a duration sufficient to obtain at least partial microbial reduction. The duration depends on the temperature and the desired level of microbial reduction. Preferably, the duration is sufficient to reduce content of colony forming units by at least 99%, more preferably by at least 99.9%, even more preferably by at least 99.99% and most preferably by at least 99.999%.

The heat-treatment of the milk fat globule concentrate may e.g. involves heating the concentrate to a temperature in the range of 70-160 degrees C., most preferably 70-95 degrees C. and preferably holding the product stream in this temperature range for 1-600 seconds, most preferably for 5-120 seconds.

Another preferred type of MFG sources are milk fat globule concentrates prepared by a process comprising the steps of:
A) providing a milk fat globule-containing dairy liquid (mfl) comprising total fat in an amount of 3-50% w/w,
B) subjecting the mfl to centrifugal fat separation to concentrate the mfl to a total fat content of at least 50% w/w, and if the mfl already contains 50% w/w fat the centrifugal fat separation concentrates the mfl to an even higher fat content.

The milk fat globule concentrates obtained from step 2) of the process may be used as such for preparing the lmc or may be heat-treated as described below prior to the preparation of the lmc.

Features and preferences described in the context of the mfl of step 1) equally apply to the mfl of step A).

In other preferred embodiments of the present invention at least 40% w/w, more preferably at least 60% w/w, even more preferably at least 80% w/w, and most preferably at least 90% w/w of the MFG of the lmc is provided by one or more MFG source(s) prepared by a process comprising the steps of:
A) providing a milk fat globule-containing dairy liquid (mfl) comprising total fat in an amount of 3-50% w/w,
B) subjecting the mfl to centrifugal fat separation to concentrate the mfl to a total fat content of at least 50% w/w, and if the mfl already contains 50% w/w fat the centrifugal fat separation concentrates the mfl to an even higher fat content.

For example, the MFG of the lmc may be provided by one or more MFG source(s) prepared by a process comprising the steps of:
A) providing a milk fat globule-containing dairy liquid (mfl) comprising total fat in an amount of 3-50% w/w,
B) subjecting the mfl to centrifugal fat separation to concentrate the mfl to a total fat content of at least 50% w/w, and if the mfl already contains 50% w/w fat the centrifugal fat separation concentrates the mfl to an even higher fat content.

In some preferred embodiments of the present invention the lmc is prepared by a process comprising the steps of:
A) providing a milk fat globule-containing dairy liquid (mfl) comprising total fat in an amount of 3-50% w/w,
B) subjecting the mfl to centrifugal fat separation to concentrate the mfl to a total fat content of at least 50% w/w, and if the mfl already contains 50% w/w fat the centrifugal fat separation concentrates the mfl to an even higher fat content.

In some preferred embodiments of the present invention the lmc comprises MFG in an amount in the range of 50-85% w/w, more preferably in the range of 55-85% w/w, and most preferably in the range of 60-82% w/w.

The lmc contains water in addition to the MFG and casein micelles.

The lmc preferably has a water content in the range of 10-49% w/w relative to total weight of the lmc, more preferably 10-44% w/w, and most preferably in the range of 10-39% w/w relative to total weight of the lmc.

In other preferred embodiments of the present invention the lmc comprises MFG in an amount in the range of 50-70% w/w, more preferably in the range of 55-68% w/w, and most preferably in the range of 55-65% w/w.

The lmc preferably has a water content in the range of 15-49% w/w relative to total weight of the lmc, more preferably 20-44% w/w, and most preferably in the range of 25-44% w/w relative to total weight of the lmc.

The lmc often comprises total protein in an amount in the range of 0.5-5% w/w, and most preferably in the range of 1-3%.

In some preferred embodiments of the present invention the lmc comprises total protein in an amount in the range of 1.5-16% w/w relative to the water content of the lmc, more preferably 2-14% w/w, even more preferably 3-12% w/w, and most preferably in the range of 4-10% w/w relative to the water content of the lmc.

The inventors have found the presence of micellar casein to be beneficial for the present invention. In some preferred embodiments of the present invention, the lmc comprises micellar casein in an amount of at least 1.5% w/w relative to the water content of the lmc, more preferably at least 2% w/w, even more preferably at least 3% w/w, and most preferably at least 4% w/w relative to the water content of the lmc.

In some preferred embodiments of the present invention the lmc comprises micellar casein in an amount of at least 4.5% w/w relative to the water content of the lmc.

For example, it is preferred that the lmc comprises micellar casein in an amount in the range of 1.5-15% w/w relative to the water content of the lmc, more preferably 2-13% w/w, even more preferably 3-11% w/w, and most preferably in the range of 4-9% w/w relative to the water content of the lmc.

In some preferred embodiments of the present invention the lmc comprises micellar casein in an amount in the range of 4.5-10% w/w relative to the water content of the lmc.

In other preferred embodiments of the present invention the lmc comprises micellar casein in an amount in the range of 3-15% w/w relative to the water content of the lmc, more preferably 4-13% w/w, even more preferably 5-11% w/w, and most preferably in the range of 6-9% w/w relative to the water content of the lmc.

The micellar casein of the lmc is typically provided by one or more of the MFG source(s) and/or by a protein concentrate, e.g. in the form of a milk protein concentrate or a micellar casein concentrate. The micellar casein content of a MFG source can be controlled by removal or addition of micellar casein when preparing the feed used for producing the MFG source and/or by selecting conditions for producing the MFG source that retains an appropriate amount of micellar casein (e.g. by selecting a microfiltration membrane that retains most, if not all, of the micellar casein).

In some preferred embodiments of the present invention the lmc comprises micellar casein in an amount of at least 50% w/w relative to total protein, more preferably at least 80% w/w, even more preferably at least at least 90% w/w, and most preferably at least 94% w/w relative to total protein.

In other preferred embodiments of the present invention the lmc comprises micellar casein in an amount of at least 82% w/w relative to total protein, more preferably at least 83% w/w relative to total protein.

In some preferred embodiments of the present invention whey protein makes up at least 50% w/w of the protein of the lmc that is not micellar casein, more preferably at least 60% w/w, even more preferably at least 70% w/w and most preferably at least 80% w/w of the protein of the lmc that is not micellar casein.

The inventors have found that it is advantageous to limit the content of caseinates, such as e.g. sodium caseinate and/or potassium caseinate, in the lmc. In some preferred embodiments of the present invention the lmc comprises caseinates in an amount of at most 30% w/w relative to total protein, more preferably at most 20% w/w, even more preferably at most 10% w/w, and most preferably at most 5% w/w relative to total protein. Most preferably the lmc does not contain caseinates.

The pH of the lmc is typically in the near-neutral to slightly acidic pH range.

In some preferred embodiments of the present invention the lmc has a pH in the range of 4.5-8, more preferably 5.5-7.7, and most preferably 6.0-7.5.

In other preferred embodiments of the present invention of the lmc has a pH in the range of 4.5-6, more preferably 4.6-5.8, and most preferably 5.0-5.5. The inventors have found that the slightly acidic variants of the lmc give rise to butter-like products having a better shelf-life. Particularly if the slightly acidic pH is combined with the heat-treatment of step b).

pH values mentioned herein are measured at or are normalised to 25 degrees C.

Preferably the MFG contribute with a least 60% w/w of the total fat of the lmc, more preferably at least 70% w/w, even more preferably at least 80% w/w, and most preferably at least 90% w/w of the total fat of the lmc.

It is sometimes preferred that the milk fat globules contribute with substantially all fat of the lmc. This is particularly advantageous in embodiments of the invention wherein no other fat source, e.g. vegetable fat, is to be added for the production of the lmc, or wherein another fat should be added after the shearing of step c).

The lmc typically comprises at most 10% w/w non-fat solids, more preferably at most 7% w/w non-fat solids, even more preferably at most 5% w/w non-fat solids, and most preferably at most 2% w/w non-fat solids.

In the context of the present invention, the term “non-fat solids” refers to the portion of the solids of a composition, e.g. the lmc, that are not fat.

In the context of the present invention, the term “fat” covers lipids in general and e.g. include phospholipids and is measured according to Analysis B.

The inventors have found that it often is beneficial to reduce the content of carbohydrate in the lmc.

The lmc typically comprises at most 10% w/w carbohydrate relative to the lmc, more preferably at most 5% w/w, even more preferably at most 2% w/w, and most preferably at most 1.5% w/w carbohydrate relative to the lmc.

The inventors have seen indications that a low content of carbohydrate in the lmc improves the shelf-life of the resulting butter-like product. Thus, in some preferred embodiments the lmc comprises at most 1.0% w/w carbohydrate relative to the lmc, more preferably at most 0.7% w/w, even more preferably at most 0.2% w/w, and most preferably at most 0.1% w/w carbohydrate relative to the lmc.

The lmc will also typically contain minerals provided by the MFG source(s) and, if used, the one or more additional ingredients.

The inventors have found it beneficial that the MFG of the lmc does not contain fat crystals.

In step a) the lmc preferably has a temperature in the range of 20-65 degrees C., more preferably 30-64 degrees C., even more preferably 40-63 degrees C., and most preferably 50-62 degrees C.

In some preferred embodiments of the invention, the lmc comprises, or even consists of:
MFG source having a MFG content in the range of 55-65% w/w in an amount of 85-96% w/w of the lmc
Sodium chloride in an amount of 0.2-2% w/w of the lmc
Fermented milk in an amount of 1-4% w/w of the lmc
Vegetable fat in an amount of 0-10% w/w of the lmc.

Step b) is optional in the sense that some preferred embodiments of the invention do not contain the heat-treatment of step b). However, other preferred embodiments do contain the heat-treatment of step b) which is performed prior to step c).

Therefore, in preferred embodiments of the present invention the method furthermore comprises subjecting the lmc to a heat-treatment in which the lmc is heated to a temperature of at least 66 degrees C.

The heat-treatment of step b) preferably involves heating the lmc to a temperature in the range of 70-160 degrees C., most preferably 85-100 degrees C. and preferably holding the lmc in this temperature range for 0.1-600 seconds, most preferably 5-60 seconds.

In some preferred embodiments of the present invention the heat-treatment of step b) involves a UHT treatment wherein the lmc is heated to a temperature in the range of 140-160 degrees C. for a duration sufficient to sterilise the lmc. The embodiment is preferably combined with aseptic conditions during the subsequent processing and packaging and gives rise to a sterile, but-ter-like product having a very long shelf-life.

Step b) may be implemented by direct and/or indirect heating, and may be performed using a plate heat-exchanger, a tubular heat-exchanger, direct steam injection, and/or steam infusion.

Step b) may furthermore contain a cooling step in which heat-treated lmc is cooled to the temperature required during the step c). The is e.g. relevant if the heat-treatment temperature of step b) is higher than the required temperature of step c).

Step c) involves subjecting the lmc obtained from step a) or b) to a shearing step, wherein the temperature of the lmc during the shearing step is in the range of 25-100 degrees C., thereby obtaining a milk fat intermediate.

In some preferred embodiments of the present invention the shearing of step c) is performed using a pressure-based homogenizer and/or a mechanical homogenizer.

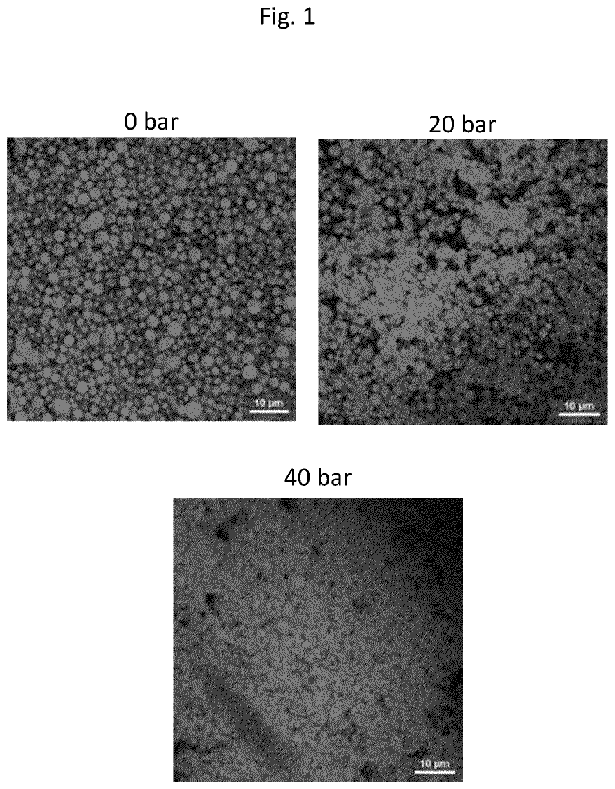

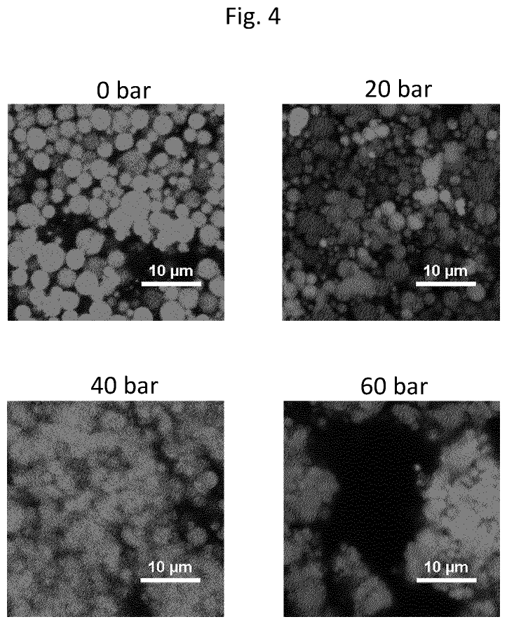

The shearing of step c) is preferably sufficient to cause partial coalescence of the MFG. Partial coalescence of the MFG is easily detected by microscopy (see e.g. FIGS. 1 and 4).

Preferably, the duration of the shearing of step c) is sufficient to create a milk fat intermediate having firmness of at least 25 g (grams) at 5 degrees C. when determined according to Analysis E, more preferably at least 50 g at 5 degrees C., even more preferably at least 100 g at 5 degrees C., and most preferably at least 200 g at 5 degrees C.

In some preferred embodiments of the present invention, the duration of the shearing of step c) is sufficient to create a milk fat intermediate having a firmness in the range of 25-500 g at 5 degrees C. when determined according to Analysis E, more preferably 50-450 g at 5 degrees C., even more preferably 100-400 g at 5 degrees C., and most preferably 200-400 g at 5 degrees C.

In some preferred embodiments of the present invention the temperature of the lmc during the shearing is preferably in the range of 25-100 degrees C., more preferably 30-95 degrees C., even more preferably 40-80 degrees C., and most preferably 50-65 degrees C.

It is sometimes preferred that the MFG of the lmc does not contain fat crystals during the shearing of step c).

However, in other preferred embodiments of the present invention, the temperature of the lmc during the shearing is in the range of 70-100 degrees C., more preferably 75-98 degrees C., even more preferably 80-96 degrees C., and most preferably 85-95 degrees C. The inventors have seen indications that high-temperature shearing provides a better shelf-life of the resulting butter-like product.

In some preferred embodiments of the present invention the shearing of step c) involves the use of a pressure-based homogenizer, preferably operated with a pressure difference in the range of 5-300 bar, more preferably 10-200 bar, even more preferably 15-150 bar and most preferably 20-100 bar. Pressure-based homogenizers operate by forcing the liquid to be homogenized through a small orifice or gap with a high positive pressure acting on the liquid to be homogenized.

The inventors have found that it is possible to increase the firmness of the butter-like product by increasing the pressure of the pressure-based homogenizer.

In other preferred embodiments of the present invention the shearing of step c) involves the use of mechanical homogenizer, e.g. in the form of a rotor-stator type homogenizer, a scraped surface heat exchanger or a high shear mixer.

A benefit of the present invention is that no buttermilk or similar side streams are produces during the shearing step contrary to the traditional butter-making process which results in the production of buttermilk in addition to the butter.

Step d) is optional in the sense that some preferred embodiments of the invention do not contain the addition of further ingredients of step d). However, other preferred embodiments do contain the step d) of combining the milk fat intermediate and one or more further ingredient(s). When included in the method, step d) results in the formation of a mixture which preferably have the same composition as the final butter-like product.

Thus, in some preferred embodiments of the present invention the method furthermore comprises step d) of combining the milk fat intermediate and one or more further ingredient(s).

The milk fat intermediate and one or more further ingredient(s) are typically combined by blending or mixing.

Preferably, the one or more further ingredient(s) comprise one or more of:
water
fermented milk product, preferably added in an amount in the range of 1-5% w/w relative to the weight of the mixture, more preferably 1.2-4%, and most preferably in the range of 1.5-3% w/w relative to the weight of the mixture,
sodium chloride, preferably added in an amount in the range of 0.1-4.5% w/w relative to the weight of the mixture, more preferably 0.5-3.0% w/w, and most preferably 0.8-1.5% w/w relative to the weight of the mixture,
a flavouring agent, preferably diacetyl,
a colouring agent,
a food acceptable preservative, preferably sodium sorbate,
a polysaccharide hydrocolloid,
a fat source, preferably vegetable fat and/or a regular butter,
a food acceptable antioxidant, and
a vitamin.

In some preferred embodiments of the present invention the milk fat intermediate contributes with at least 50% w/w of the mixture of step d), more preferably at least 60% w/w, even more preferably at least 70% w/w, and most preferably at least 80% w/w of the mixture of step d).

In other preferred embodiments of the present invention the milk fat intermediate contributes with 50-80% w/w of the mixture of step d), more preferably at least 50-75% w/w, even more preferably 50-70% w/w, and most preferably 50-60% w/w of the mixture of step d).

In further preferred embodiments of the present invention the milk fat intermediate contributes with at least 85% w/w of the mixture of step d), more preferably at least 90% w/w, even more preferably at least 95% w/w, and most preferably at least 99% w/w of the mixture of step d).

In further preferred embodiments of the present invention the milk fat intermediate contributes with 80-99.5% w/w of the mixture of step d), more preferably at least 82-99.0% w/w, even more preferably 84-98% w/w, and most preferably 85-97% w/w of the mixture of step d).

In some preferred embodiments of the present invention the milk fat intermediate is used in step d) in an amount sufficient to contribute with at least 50% w/w of the total fat of the mixture resulting from step d), more preferably at least 60% w/w, more preferably at least 70% w/w, and most preferably at least 80% w/w of the total fat the mixture resulting from step d.

Often the milk fat intermediate is used in step d) in an amount sufficient to contribute with 40-99% w/w of the total fat of the mixture resulting from step d), more preferably 45-90 w/w, more preferably 50-80% w/w, and most preferably 52-70% w/w of the total fat of the mixture resulting from step d).

A substantial part of the fat of the mixture of step d) that is not provided by the milk fat intermediate is typically provided by one or more vegetable fats.

However, in other preferred embodiments of the present invention the milk fat intermediate is used in step d) in an amount sufficient to contribute with at least 99% w/w of the total fat of the mixture resulting from step d) and may even be the only fat source of the mixture.

The milk fat intermediate will typically make up a substantial amount of the mixture resulting from step d).

In some preferred embodiments of the present invention the milk fat intermediate is used in step d) in an amount of at least 50% w/w of the mixture resulting from step d), more preferably at least 60% w/w, more preferably at least 70% w/w, and most preferably at least 80% w/w of the mixture resulting from step d.

Often the milk fat intermediate is used in step d) in an amount of 40-99% w/w of the mixture resulting from step d), more preferably 45-90 w/w, more preferably 50-80% w/w, and most preferably 52-70% w/w of the mixture resulting from step d).

Step d) may be implemented by combining and mixing all ingredients and the milk fat intermediate in a single step or by mixing milk fat intermediate and the ingredients one by one.

The total amount of added sodium chloride, i.e. added as an additional ingredient and/or a further ingredient, is preferably 0-4.5% w/w relative to the weight of the mixture, more preferably 0.5-3.0% w/w, and most preferably 0.8-1.5% w/w relative to the weight of the mixture.

The mixture of step d) preferably has the same chemical composition as the butter-like product.

The total amount of added fermented milk product, i.e. added as an additional ingredient and/or a further ingredient, is preferably the range of 0-5% w/w relative to the weight of the mixture, more preferably 0.5-4%, and most preferably in the range of 1.0-3% w/w relative to the weight of the mixture.

Fermented milk is a preferred fermented milk product.

If used, the total amount of added vegetable fat, i.e. added as an additional ingredient and/or a further ingredient, is preferably the range of 1-30% w/w relative to the weight of the mixture, more preferably 2-25%, and most preferably in the range of 5-20% w/w relative to the weight of the mixture.

The temperature of the product stream during step d) may be in the range of 0-100 degrees C., but is typically in the range of 30-90 degrees C., preferably 35-75 degrees C., more preferably 40-70 degrees C., and most preferably 45-65 degrees C.

However, in some preferred embodiments of the present invention the temperature of the product stream during step d) may be in the range of 60-100 degrees C., more preferably 65-96 degrees C., even more preferably 70-94 degrees C., and most preferably 70-90 degrees C. The inventors have seen indications that high-temperature mixing during step d) provides a better shelf-life of the resulting butter-like product.

The present method may furthermore involve mechanical processing of one or more product stream(s) after step c). For example, step d) may furthermore comprise mechanical processing of the obtained mixture. The mechanical processing may be performed by additional stirring, mixing or working of the mixture.

Step e) is optional in the sense that some preferred embodiments of the invention do not contain the packaging of step e). However, other preferred embodiments do contain the step e) of packaging the butter-like product.

Thus, in some preferred embodiments of the present invention the method of the invention furthermore comprises a packaging step during which the butter-like product is packaged.

The temperature of the product stream during step e) is typically in the range of 0-89 degrees C.

In some preferred embodiments of the present invention the temperature of the product stream during step e) is in the range of 30-90 degrees C., preferably 35-75 degrees C., more preferably 40-70 degrees C., and most preferably 45-65 degrees C.

However, in other preferred embodiments of the present invention, the temperature of the product stream during step e) is in the range of 60-100 degrees C., more preferably 65-96 degrees C., even more preferably 70-94 degrees C., and most preferably 70-90 degrees C. The inventors have seen indications that high-temperature shearing provides a better shelf-life of the resulting butter-like product.

Alternatively, and particularly if cold-filling is preferred, the temperature of the product stream during step e) is in the range of 0-40 degrees C., more preferably 10-40 degrees C., even more preferably 20-40 degrees C., and most preferably 30-40 degrees C.

In some preferred embodiments of the present invention step e) is performed under aseptic conditions which has the benefit of improving the shelf-life of the butter-like product, and to make it feasible to produce a sterile, butter-like product. In some preferred embodiments of the present invention the butter-like product in packaged form is sterile.

In other preferred embodiments of the present invention the method furthermore comprising a cooling step after the shearing of step c), preferably cooling the product-stream to a temperature of at most 10 degrees C., more preferably at most 6 degrees C. and most preferably at most 4 degrees C.

Preferably, a cooling step is performed after the packaging of step e).

The method may furthermore comprise a heat-treatment step performed after step c).

The heat-treatment performed after step c) preferably involves heating the product stream to a temperature in the range of 70-160 degrees C., most preferably 85-95 degrees C. and preferably holding the product stream in this temperature range for 1-600 seconds, more preferably 5-60 seconds.

In some preferred embodiments of the present invention the heat-treatment performed after step c) involves a UHT treatment wherein the lmc is heated to a temperature in the range of 140-160 degrees C. for a duration sufficient to sterilise the product stream. This embodiment can advantageously be combined with aseptic conditions during the subsequent processing and packaging and gives rise to a sterile, butter-like product having a very long shelf-life.

In the context of the present invention the term “product stream” pertains to the composition that is subjected to the process in question; the term is used when a process step may be applied during difference stage of the process, e.g. on the final product or an intermediary product. The term product stream does not imply that the method is implemented as a continuous process.

Embodiments and preferences described in the context of the heat-treatment of step b) equally apply to the heat-treatment which may be implemented after step c).

In some preferred embodiments of the present invention the present method is implemented as a continuous process and it is an advantage of the method that it is suitable for continuous processing.

In other preferred embodiments of the present invention the present method is implemented as a batch or semi-batch method.

In some particularly preferred embodiments of the invention the method comprising the steps of:
a) providing a liquid, milk fat globule composition (lmc), preferably having a temperature in the range of 20-65 degrees C.,
the lmc comprising:
   i) milk fat globules (MFG) in an amount of 50-85% w/w of the lmc,
   ii) 1.5-15% w/w micellar casein relative to the weight of the water content of the lmc,
   iii) water in an amount of 10-49% w/w, and
   iv) optionally, one or more additional component(s),
the lmc comprises, and is prepared by mixing:
MFG source having a MFG content in the range of 55-65% w/w in an amount of 85-96% w/w of the lmc,
sodium chloride in an amount of 0.2-2% w/w of the lmc
fermented milk in an amount of 1-4% w/w of the lmc
vegetable fat in an amount of 0-10% w/w of the lmc.
b) optionally, subjecting the lmc to a heat-treatment in which the lmc is heated to a temperature of at least 66 degrees C.,
c) subjecting the lmc obtained from step a) or b) to a shearing step, and wherein the temperature of the lmc during the shearing step is in the range of 25-100 degrees C., thereby obtaining a milk fat intermediate,
e) optionally, packaging the butter-like product which is the milk intermediate obtained from step c).

Preferred butter-like products of the invention are obtainable by the particularly preferred method embodiments described above.

In other particularly preferred embodiments of the invention the method comprising the steps of:
a) providing a liquid, milk fat globule composition (lmc), preferably having a temperature in the range of 20-65 degrees C.,
the lmc comprising:
   i) milk fat globules (MFG) in an amount of 50-85% w/w of the lmc,
   ii) 1.5-15% w/w micellar casein relative to the weight of the water content of the lmc,
   iii) water in an amount of 10-49% w/w, and
   iv) optionally, one or more additional component(s),
the lmc comprises, and is prepared by mixing:
MFG source having a MFG content in the range of 55-65% w/w in an amount of 94-98% w/w of the lmc,
sodium chloride in an amount of 0.2-2% w/w of the lmc,
fermented milk in an amount of 1-4% w/w of the lmc,
b) optionally, subjecting the lmc to a heat-treatment in which the lmc is heated to a temperature of at least 66 degrees C.,
c) subjecting the lmc obtained from step a) or b) to a shearing step, and wherein the temperature of the lmc during the shearing step is in the range of 25-100 degrees C., thereby obtaining a milk fat intermediate,
d) combining the milk fat intermediate the final mixture and one or more further ingredient(s) comprising vegetable fat, wherein the milk fat intermediate is used in an amount of 80-95% w/w of the final mixture and vegetable is used in an amount of 2-20
e) optionally, packaging the butter-like product which is the final mixture of step d).

Preferred butter-like products of the invention are obtainable by the particularly preferred method embodiments described above.

In further particularly preferred embodiments of the invention the method comprising the steps of:
a) providing a liquid, milk fat globule composition (lmc), preferably having a temperature in the range of 20-65 degrees C.,
the lmc comprising:
   i) milk fat globules (MFG) in an amount of 50-85% w/w of the lmc,
   ii) 1.5-15% w/w micellar casein relative to the weight of the water content of the lmc,
   iii) water in an amount of 10-49% w/w, and
   iv) optionally, one or more additional component(s), the lmc comprises one or more MFG source having a MFG content in the range of 55-65% w/w in an amount of at least 95% w/w of the lmc,
b) optionally, subjecting the lmc to a heat-treatment in which the lmc is heated to a temperature of at least 66 degrees C.,
c) subjecting the lmc obtained from step a) or b) to a shearing step, and wherein the temperature of the lmc during the shearing step is in the range of 25-100 degrees C., thereby obtaining a milk fat intermediate,
d) combining the milk fat intermediate the final mixture and one or more further ingredient(s) comprising vegetable fat, sodium chloride, and fermented milk, wherein the milk fat intermediate is used in an amount of 80-95% w/w of the final mixture, vegetable fat is used in an amount of 2-15% w/w of the final mixture, sodium chloride is used in an amount of 0.2-2% w/w of the final mixture, and fermented milk is used in an amount of 1-4% w/w of the lmc,
e) optionally, packaging the butter-like product which is the final mixture obtained from step d).

Preferred butter-like products of the invention are obtainable by the particularly preferred method embodiments described above.

In some particularly preferred embodiments of the invention the method comprising the steps of:
a) providing a liquid, milk fat globule composition (lmc), preferably having a temperature in the range of 20-65 degrees C.,
the lmc comprising:
   i) milk fat globules (MFG) in an amount of 50-85% w/w of the lmc,
   ii) 1.5-15% w/w micellar casein relative to the weight of the water content of the lmc,
   iii) water in an amount of 10-49% w/w, and
   iv) optionally, one or more additional component(s),
b) optionally, subjecting the lmc to a heat-treatment in which the lmc is heated to a temperature of at least 66 degrees C.,
c) subjecting the lmc obtained from step a) or b) to a shearing step, and wherein the temperature of the lmc during the shearing step is in the range of 25-100 degrees C., thereby obtaining a milk fat intermediate,
e) optionally, packaging the butter-like product which is the milk intermediate obtained from step c).

Preferred butter-like products of the invention are obtainable by the particularly preferred method embodiments described above.

In other particularly preferred embodiments of the invention the method comprising the steps of:
a) providing a liquid, milk fat globule composition (lmc), preferably having a temperature in the range of 20-65 degrees C.,
the lmc comprising:
   i) milk fat globules (MFG) in an amount of 50-85% w/w of the lmc,
   ii) 1.5-15% w/w micellar casein relative to the weight of the water content of the lmc,
   iii) water in an amount of 10-49% w/w, and
   iv) optionally, one or more additional component(s),
b) optionally, subjecting the lmc to a heat-treatment in which the lmc is heated to a temperature of at least 66 degrees C.,
c) subjecting the lmc obtained from step a) or b) to a shearing step, and wherein the temperature of the lmc during the shearing step is in the range of 25-100 degrees C., thereby obtaining a milk fat intermediate,
d) combining the milk fat intermediate the final mixture and one or more further ingredient(s) comprising vegetable fat, wherein the milk fat intermediate is used in an amount of 50-95% w/w of the final mixture,
e) optionally, packaging the butter-like product, which is the final mixture of step d).

Preferred butter-like products of the invention are obtainable by the particularly preferred method embodiments described above.

In further particularly preferred embodiments of the invention the method comprising the steps of:
a) providing a liquid, milk fat globule composition (lmc), preferably having a temperature in the range of 20-65 degrees C.,
the lmc comprising:
   i) milk fat globules (MFG) in an amount of 50-85% w/w of the lmc,
   ii) 1.5-15% w/w micellar casein relative to the weight of the water content of the lmc,
   iii) water in an amount of 10-49% w/w, and
   iv) optionally, one or more additional component(s),
b) optionally, subjecting the lmc to a heat-treatment in which the lmc is heated to a temperature of at least 66 degrees C.,
c) subjecting the lmc obtained from step a) or b) to a shearing step, and wherein the temperature of the lmc during the shearing step is in the range of 25-100 degrees C., thereby obtaining a milk fat intermediate,
d) combining the milk fat intermediate the final mixture and one or more further ingredient(s) comprising vegetable fat, sodium chloride, and fermented milk, wherein the milk fat intermediate is used in an amount of 80-95% w/w of the final mixture,
e) optionally, packaging the butter-like product, which is the final mixture obtained from step d).

Preferred butter-like products of the invention are obtainable by the particularly preferred method embodiments described above.

Yet an aspect of the invention pertains to the butter-like product obtainable by the method defined herein.

The butter-like product contains at least 50% w/w fat relative to its total weight and at least 50% w/w milk fat relative to the total amount of fat.

In some preferred embodiments of the present invention the butter-like product comprises:
total fat in an amount in the range of 50-85% w/w, and preferably in the range of 60-85% w/w,
water in an amount in the range of 10-48% w/w, and preferably in the range of 10-39% w/w
total protein in an amount in the range of 0.1-5% w/w, and has a pH in the range of 4.5-8.

In some preferred embodiments of the present invention the milk fat intermediate is used in an amount sufficient to provide at least 50% w/w of the total fat of the butter-like product, more preferably at least 60% w/w, even more preferably at least 70% w/w, and most preferably at least 80% w/w of the total fat of the butter-like product.

In other preferred embodiments of the present invention the milk fat intermediate is used in an amount sufficient to provide 50-80% w/w of the total fat of the butter-like product, more preferably at least 21-50% w/w, even more preferably 50-70% w/w, and most preferably 50-60% w/w of the total fat of the butter-like product.

In further preferred embodiments of the present invention the milk fat intermediate is used in an amount sufficient to provide at least 85% w/w of the total fat of the butter-like product, more preferably at least 90% w/w, even more preferably at least 95% w/w, and most preferably at least 99% w/w of the total fat of the butter-like product.

In some preferred embodiments of the present invention the milk fat intermediate contributes with at least 50% w/w of the butter-like product, more preferably at least 60% w/w, even more preferably at least 70% w/w, and most preferably at least 80% w/w of the butter-like product.

In other preferred embodiments of the present invention the milk fat intermediate contributes with 50-80% w/w of the butter-like product, more preferably at least 50-75% w/w, even more preferably 50-70% w/w, and most preferably 50-60% w/w of the butter-like product.

In further preferred embodiments of the present invention the milk fat intermediate contributes with at least 85% w/w of the butter-like product, more preferably at least 90% w/w, even more preferably at least 95% w/w, and most preferably at least 99% w/w of the butter-like product.

In further preferred embodiments of the present invention the milk fat intermediate contributes with 80-99.5% w/w of the butter-like product, more preferably at least 82-99.0% w/w, even more preferably 84-98% w/w, and most preferably 85-97% w/w of the butter-like product.

In some preferred embodiments of the invention the milk fat intermediate obtained from step c) is the butter-like product. These embodiments are particularly relevant for methods that do not contain step d) and wherein milk fat intermediate the packaged, optionally following one or more of a pasteurisation step, a cooling step, and a mechanically processing step. The butter-like product preferably comprises total protein in an amount in the range of 0.1-5% w/w, more preferably 0.2-4% w/w, even more preferably 0.4-3% w/w, and most preferably 0.5-2% w/w.

In other preferred embodiments of the present invention the butter-like product comprises total protein in an amount in the range of 0.1-2% w/w, more preferably 0.1-1.5% w/w, even more preferably 0.1-1.0% w/w, and most preferably 0.1-2% w/w.

The butter-like product typically has a weight ratio between casein and whey protein of 70:30-99:1, more preferably 80:20-98:2, even more preferably 85:15-98:2, and most preferably 90:10-98:2.

The butter-like product typically comprises total fat in an amount in the range of 50-90% w/w, more preferably 55-85% w/w, even more preferably 60-84% w/w, and most preferably 80-84% w/w.

In some preferred embodiments of the present invention the butter-like product comprises total fat in an amount in the range of 50-75% w/w, more preferably 50-72% w/w, even more preferably 50-70% w/w, and most preferably 50-65% w/w. These embodiments are preferred if low fat butter-like products are required.

The butter-like product typically comprises carbohydrate in an amount in the range of 0-10% w/w, more preferably 0-8% w/w, even more preferably 0-6% w/w, and most preferably 0-5% w/w.

The butter-like product may for example comprises carbohydrate in an amount in the range of 0.1-10% w/w, more preferably 0.2-8% w/w, even more preferably 0.3-6% w/w, and most preferably 0.4-5% w/w.

The pH of the butter-like product is typically in the near-neutral to slightly acidic pH range.

In some preferred embodiments of the present invention the butter-like product has a pH in the range of 4.5-8, more preferably 5.5-7.7, and most preferably 6.0-7.5.

In other preferred embodiments of the present invention of the butter-like product has a pH in the range of 4.5-6, more preferably 4.6-5.8, and most preferably 5.0-5.5. The inventors have found that the slightly acidic variants of the butter-like product give rise to a better shelf-life.

The butter-like product typically comprises at most 10% w/w non-fat solids, more preferably at most 7% w/w non-fat solids, even more preferably at most 5% w/w non-fat solids, and most preferably at most 2% w/w non-fat solids.

In some preferred embodiments of the present invention the butter-like product comprises:
the milk fat intermediate in an amount in the range of 50-100% w/w,
total fat in an amount in the range of 50-85% w/w, and preferably in the range of 60-85% w/w,
water in an amount in the range of 10-48% w/w, and preferably in the range of 10-39% w/w
total protein in an amount in the range of 0.1-5% w/w, and the butter-like product preferably has a pH in the range of 4.5-7.5.

Yet an aspect of the invention pertains to the use of the butter-like product as an ingredient in the production of a food product, preferably wherein the butter-like product is used in amount to provide at least 5% w/w of the fat of the food product, more preferably at least 10% w/w, even more preferably at least 15% w/w, and most preferably at least 20% w/w.

Some particularly preferred embodiments of the invention are described in the following preferred numbered embodiments.

Preferred numbered embodiment 1. A method of producing a butter-like product, the method comprising the steps of:
a) providing a liquid, milk fat globule composition (lmc), preferably having a temperature in the range of 20-65 degrees C.,
the lmc comprising:
   i) milk fat globules (MFG) in an amount of at least 50% w/w of the lmc,
   ii) at least 1.5% w/w micellar casein relative to the weight of the water content of the lmc,
   iii) water, and
   iv) optionally, one or more additional component(s),
b) optionally, but preferably, subjecting the lmc to a heat-treatment in which the lmc is heated to a temperature of at least 66 degrees C.,
c) subjecting the lmc obtained from step a) or b) to a shearing step, and wherein the temperature of the lmc during the shearing step is in the range of 25-100 degrees C., thereby obtaining a milk fat intermediate,
d) optionally, combining the milk fat intermediate and one or more further ingredient(s), thereby obtaining a mixture, and
e) optionally, packaging the milk fat intermediate obtained from step c) or the mixture obtained from step d),
and wherein the butter-like product preferably is the milk fat intermediate obtained from step c), the mixture obtained from step d), or the packaged product obtained from step e).

Preferred numbered embodiment 2. The method according to preferred numbered embodiment 1 wherein at least 50% w/w of the MFG of the lmc is provided by one or more MFG source(s) containing MFG in an amount of at least 50% w/w relative to the weight of the source, preferably prepared by microfiltration and/or centrifugation of milk, cream, or mixtures thereof.

Preferred numbered embodiment 3. The method according to preferred numbered embodiment 1 or 2 wherein at least 40% w/w, more preferably at least 60% w/w, even more preferably at least 80% w/w, and most preferably at least 90% w/w of the MFG of the lmc is provided by one or more MFG source(s) prepared by a process comprising the steps of:
1) providing a milk fat globule-containing dairy liquid (mfl) comprising total fat in an amount of 3-50% w/w,
2) subjecting the mfl to microfiltration (MF) to concentrate the mfl to a total fat content of at least 50% w/w, and if the mfl already contains 50% w/w fat the microfiltration concentrates the mfl to an even higher fat content.

Preferred numbered embodiment 4. The method according to any one of the preceding preferred numbered embodiments, wherein the lmc is prepared by a process comprising the steps of:
1) providing a milk fat globule-containing dairy liquid (mfl) comprising total fat in an amount of 3-50% w/w,
2) subjecting the mfl to microfiltration (MF) to concentrate the mfl to a total fat content of at least 50% w/w, and if the mfl already contains 50% w/w fat the microfiltration concentrates the mfl to an even higher fat content.

Preferred numbered embodiment 5. The method according to any one of the preceding preferred numbered embodiments, wherein at least 40% w/w, more preferably at least 60% w/w, even more preferably at least 80% w/w, and most preferably at least 90% w/w of the MFG of the lmc is provided by one or more MFG source(s) prepared by a process comprising the steps of:
A) providing a milk fat globule-containing dairy liquid (mfl) comprising total fat in an amount of 3-50% w/w,
B) subjecting the mfl to centrifugal fat separation to concentrate the mfl to a total fat content of at least 50% w/w, and if the mfl already contains 50% w/w fat the centrifugation concentrates the mfl to an even higher fat content.

Preferred numbered embodiment 6. The method according to any one of the preceding preferred numbered embodiments, wherein the lmc is prepared by a process comprising the steps of:
A) providing a milk fat globule-containing dairy liquid comprising total fat in an amount of 3-50% w/w,
B) subjecting the mfl to centrifugal fat separation to concentrate the mfl to a total fat content of at least 50% w/w, and if the mfl already contains 50% w/w fat the centrifugal fat separation concentrates the mfl to an even higher fat content.
   Preferred numbered embodiment 7. The method according to any one of the preceding preferred numbered embodiments wherein the lmc comprises one or more MFG source(s) in an amount sufficient to contribute with at least 50% w/w MFG relative to the weight of the lmc, and optionally comprises one or more additional ingredient(s).

Preferred numbered embodiment 8. The method according to any one of the preceding preferred numbered embodiments wherein the lmc comprises the one or more additional ingredient(s) which comprise one or more of the following:
water
fermented milk product
sodium chloride,
a flavouring agent, preferably diacetyl,
a colouring agent,
a food acceptable preservative, preferably sodium sorbate,
a polysaccharide hydrocolloid,
a protein concentrate, preferably a whey protein concentrate, a concentrate of micellar casein, and/or a milk protein concentrate,
a fat source, preferably vegetable fat and/or butter,
a food acceptable antioxidant, and
a vitamin.

Preferred numbered embodiment 9. The method according to any one of the preceding preferred numbered embodiments wherein the lmc is prepared by one of the following:
providing a single MFG source which will be the lmc,
mixing two or more MFG sources,
mixing a single MFG source with one or more additional ingredient(s), or
mixing two or more MFG sources with one or more additional ingredient(s).

Preferred numbered embodiment 10. The method according to any one of the preceding preferred numbered embodiments wherein the lmc is prepared by mixing one or more MFG source(s) with one or more additional ingredients in amounts sufficient to obtain the desired composition of the lmc, e.g. in relation to the content of MFG, total fat, total protein, micellar casein, water, and other components.

Preferred numbered embodiment 11. The method according to any one of the preceding preferred numbered embodiments wherein the lmc comprises MFG in an amount in the range of 50-85% w/w, more preferably in the range of 55-85% w/w, and most preferably in the range of 50-82% w/w.

Preferred numbered embodiment 11a. The method according to any one of the preceding preferred numbered embodiments wherein the lmc has a water content in the range of 10-49% w/w relative to total weight of the lmc, more preferably 10-44% w/w, and most preferably in the range of 10-39% w/w relative to total weight of the lmc.

Preferred numbered embodiment 12. The method according to any one of the preceding preferred numbered embodiments wherein the lmc comprises MFG in an amount in the range of 50-70% w/w, more preferably in the range of 55-68% w/w, and most preferably in the range of 55-65% w/w.

Preferred numbered embodiment 12a. The method according to any one of the preceding preferred numbered embodiments wherein the lmc has a water content in the range of 15-49% w/w relative to total weight of the lmc, more preferably 20-44% w/w, and most preferably in the range of 25-44% w/w relative to total weight of the lmc.

Preferred numbered embodiment 13. The method according to any one of the preceding preferred numbered embodiments wherein the lmc comprises total protein in an amount in the range of 0.5-5% w/w, and most preferably in the range of 1-3%.

Preferred numbered embodiment 14. The method according to any one of the preceding preferred numbered embodiments wherein the lmc comprises total protein in an amount in the range of 1.5-16% w/w relative to the water content of the lmc, more preferably 2-14% w/w, even more preferably 3-12% w/w, and most preferably in the range of 4-10% w/w relative to the water content of the lmc.

Preferred numbered embodiment 15. The method according to any one of the preceding preferred numbered embodiments wherein the lmc comprises micellar casein in an amount in the range of 1.5-15% w/w relative to the water content of the lmc, more preferably 2-13% w/w, even more preferably 3-11% w/w, and most preferably in the range of 4-9% w/w relative to the water content of the lmc.

Preferred numbered embodiment 16. The method according to any one of the preceding preferred numbered embodiments wherein the lmc comprises micellar casein in an amount of at least 50% w/w relative to total protein, more preferably at least 80% w/w, even more preferably at least at least 90% w/w, and most preferably at least 94% w/w relative to total protein.

Preferred numbered embodiment 17. The method according to any one of the preceding preferred numbered embodiments wherein whey protein makes up at least 50% w/w of the protein of the lmc that is not micellar casein, more preferably at least 60% w/w, even more preferably at least 70% w/w and most preferably at least 80% w/w of the protein of the lmc that is not micellar casein.

Preferred numbered embodiment 18. The method according to any one of the preceding preferred numbered embodiments wherein the lmc comprises caseinates in an amount of at most 30% w/w relative to total protein, more preferably at most 20% w/w, even more preferably at most 10% w/w, and most preferably at most 5% w/w relative to total protein.

Preferred numbered embodiment 19. The method according to any one of the preceding preferred numbered embodiments wherein the lmc has a pH in the range of 4.5-8, more preferably 5.5-7.7, and most preferably 6.0-7.5.

Preferred numbered embodiment 20. The method according to any one of the preceding preferred numbered embodiments wherein the lmc has a pH in the range of 4.5-6, more preferably 4.6-5.8, and most preferably 5.0-5.5.

Preferred numbered embodiment 21. The method according to any one of the preceding preferred numbered embodiments wherein the milk fat globules contribute with a least with a least 60% w/w of the total fat of the lmc, more preferably at least 70% w/w, even more preferably at least 80% w/w, and most preferably at least 90% w/w of the total fat of the lmc.

Preferred numbered embodiment 22. The method according to any one of the preceding preferred numbered embodiments wherein the milk fat globules contribute with substantially all fat of the lmc.

Preferred numbered embodiment 23. The method according to any one of the preceding preferred numbered embodiments wherein the lmc comprises at most 10% w/w non-fat solids, more preferably at most 7% w/w non-fat solids, even more preferably at most 5% w/w non-fat solids, and most preferably at most 2% w/w non-fat solids.

Preferred numbered embodiment 23a. The method according to any one of the preceding preferred numbered embodiments wherein the lmc comprises, or even consists of:
MFG source having a MFG content in the range of 55-65% w/w in an amount of 85-96% w/w of the lmc
Sodium chloride in an amount of 0.2-2% w/w of the lmc
Fermented milk in an amount of 1-4% w/w of the lmc
Vegetable fat in an amount of 0-10% w/w of the lmc.

Preferred numbered embodiment 24. The method according to any one of the preceding preferred numbered embodiments wherein the lmc of step a) has a temperature in the range of 20-65 degrees C., more preferably 30-64 degrees C., even more preferably 40-63 degrees C., and most preferably 50-62 degrees C.

Preferred numbered embodiment 25. The method according to any one of the preceding preferred numbered embodiments furthermore comprises subjecting the lmc to a heat-treatment in which the lmc is heated to a temperature of at least 66 degrees C.

Preferred numbered embodiment 26. The method according to preferred numbered embodiment 25, wherein the heat-treatment involves heating the lmc to a temperature in the range of 70-160 degrees C., most preferably 85-100 degrees C. and preferably holding the lmc in this temperature range for 0.1-600 seconds, more preferably 5-60 seconds.

Preferred numbered embodiment 26a. The method according to any one of the preferred numbered embodiments 25-26, wherein the heat-treatment involves subjecting the lmc to a UHT treatment wherein the lmc is heated to a temperature in the range of 140-160 degrees C. for a duration sufficient to sterilise the lmc.

Preferred numbered embodiment 27. The method according to any one of the preceding preferred numbered embodiments wherein the shearing of step c) is performed using a pressure-based homogenizer and/or a mechanical homogenizer.

Preferred numbered embodiment 28. The method according to any one of the preceding preferred numbered embodiments wherein the duration of the shearing of step c) is sufficient to create a milk fat intermediate having firmness of at least 25 g at 5 degrees C. when determined according to Analysis E, more preferably at least 50 g at 5 degrees C., even more preferably at least 100 g at 5 degrees C., and most preferably at least 200 g at 5 degrees C.

Preferred numbered embodiment 29. The method according to any one of the preceding preferred numbered embodiments wherein the duration of the shearing of step c) is sufficient to create a milk fat intermediate having a firmness in the range of 25-500 g at 5 degrees C. when determined according to Analysis E, more preferably 50-450 g at 5 degrees C., even more preferably 100-400 g at 5 degrees C., and most preferably 200-400 g at 5 degrees C.

Preferred numbered embodiment 30. The method according to any one of the preceding preferred numbered embodiments wherein the temperature of the lmc during the shearing is in the range of 25-100 degrees C., more preferably 30-95 degrees C., even more preferably 40-80 degrees C., and most preferably 50-65 degrees C.

Preferred numbered embodiment 31. The method according to any one of the preceding preferred numbered embodiments wherein the temperature of the lmc during the shearing is in the range of 70-100 degrees C., more preferably 75-98 degrees C., even more preferably 80-96 degrees C., and most preferably 85-95 degrees C.

Preferred numbered embodiment 32. The method according to any of the preceding preferred numbered embodiments wherein the shearing of step c) involves the use of a pressure-based homogenizer, preferably operated with a pressure difference in the range of 5-300 bar, more preferably 10-200 bar, even more preferably 15-150 bar and most preferably 20-100 bar.

Preferred numbered embodiment 33. The method according to any of the preceding preferred numbered embodiments wherein the shearing of step c) involves the use of mechanical homogenizer, e.g. in the form of a rotor-stator type homogenizer, a scraped surface heat exchanger or a high shear mixer.

Preferred numbered embodiment 34. The method according to any one of the preceding preferred numbered embodiments comprising step d) of combining the milk fat intermediate and one or more further ingredient(s).

Preferred numbered embodiment 35. The method according to any one of the preceding preferred numbered embodiments wherein the one or more further ingredient(s) comprise one or more of:
water
fermented milk product, preferably added in an amount in the range of 1-5% w/w relative to the weight of the mixture, more preferably 1.2-4%, and most preferably in the range of 1.5-3% w/w relative to the weight of the mixture,
sodium chloride, preferably added in an amount in the range of 0.1-4.5% w/w relative to the weight of the mixture, more preferably 0.5-3.0% w/w, and most preferably 0.8-1.5% w/w relative to the weight of the mixture,
a flavouring agent, preferably diacetyl,
a colouring agent,
a food acceptable preservative, preferably sodium sorbate,
a polysaccharide hydrocolloid,
a protein concentrate, preferably a whey protein concentrate, a concentrate of micellar casein, and/or a milk protein concentrate,
a fat source, preferably vegetable fat and/or butter,
a food acceptable antioxidant, and
a vitamin.

Preferred numbered embodiment 37. The method according to any one of the preceding preferred numbered embodiments wherein the milk fat intermediate is used in step d) in an amount sufficient to contribute with at least 50% w/w of the total fat of the mixture resulting from step d), more preferably at least 60% w/w, more preferably at least 70% w/w, and most preferably at least 80% w/w of the mixture resulting from step d).

Preferred numbered embodiment 38. The method according to any one of the preceding preferred numbered embodiments wherein the milk fat intermediate is used in step d) in an amount sufficient to contribute with 40-99% w/w of the total fat of the mixture resulting from step d), more preferably 45-90 w/w, more preferably 50-80% w/w, and most preferably 52-70% w/w of the mixture resulting from step d).

Preferred numbered embodiment 39. The method according to any one of the preceding preferred numbered embodiments wherein the temperature of the product stream during step d) is in the range of 30-90 degrees C., preferably 35-75 degrees C., more preferably 40-70 degrees C., and most preferably 45-65 degrees C.

Preferred numbered embodiment 40. The method according to any one of the preceding preferred numbered embodiments wherein the temperature of the product stream during step d) is in the range of 60-100 degrees C., more preferably 65-96 degrees C., even more preferably 70-94 degrees C., and most preferably 70-90 degrees C.

Preferred numbered embodiment 41. The method according to any one of the preceding preferred numbered embodiments furthermore comprising a packaging step during which the but-ter-like product is packaged.

Preferred numbered embodiment 42. The method according to any one of the preceding preferred numbered embodiments wherein the temperature of the product stream during step e) is in the range of 35-89 degrees C., preferably 40-75 degrees C., more preferably 45-70 degrees C., and most preferably 50-65 degrees C.

Preferred numbered embodiment 42a. The method according to any one of the preceding preferred numbered embodiments wherein the temperature of the product stream during step e) is in the range of 60-100 degrees C., more preferably 65-96 degrees C., even more preferably 70-94 degrees C., and most preferably 70-90 degrees C.

Preferred numbered embodiment 43. The method according to any one of the preceding preferred numbered embodiments furthermore comprising a cooling step after the shearing of step c), preferably cooling the product-stream to a temperature of at most 10 degrees C., more preferably at most 6 degrees C. and most preferably at most 4 degrees C.

Preferred numbered embodiment 44. The method according to preferred numbered embodiment 43, wherein a cooling step is performed after the packaging of step e).

Preferred numbered embodiment 45. The method according to any one of the preceding preferred numbered embodiments furthermore comprising a heat-treatment step performed after step c).

Preferred numbered embodiment 46. The method according to preferred numbered embodiment 45, wherein the heat-treatment step involves heating the product-stream to a temperature in the range of 70-160 degrees C., most preferably 85-95 degrees C. and preferably holding the product stream in this temperature range for 1-600 seconds, more preferably 5-60 seconds.

Preferred numbered embodiment 46a. The method according to any one of the preferred numbered embodiments 45-46, wherein the heat-treatment step involves subjecting the product-stream to be treated to a UHT treatment wherein the product stream is heated to a temperature in the range of 140-160 degrees C. for a duration sufficient to sterilise the product stream.

Preferred numbered embodiment 47. The butter-like product obtainable by the method according to one or more of preferred numbered embodiments 1-46.

Preferred numbered embodiment 48. The butter-like product to preferred numbered embodiment 47 having a pH in the range of 4.5-8, more preferably 5.5-7.7, and most preferably 6.0-7.5.

Preferred numbered embodiment 49. The butter-like product to preferred numbered embodiment 47 having a pH in the range of 4.5-6, more preferably 4.6-5.8, and most preferably 5.0-5.5.

Preferred numbered embodiment 50. The butter-like product to any one of preferred numbered embodiments 47-49 comprising:
total fat in an amount in the range of 50-85% w/w, and preferably in the range of 60-85% w/w,
water in an amount in the range of 10-48% w/w, and preferably in the range of 10-39% w/w
total protein in an amount in the range of 0.1-5% w/w, and preferably having a pH in the range of 4.5-7.5.

Preferred numbered embodiment 51. The butter-like product to any one of preferred numbered embodiments 47-50 wherein the milk fat intermediate is used in an amount sufficient to provide at least 50% w/w of the total fat of the butter-like product, more preferably at least 60% w/w, even more preferably at least 70% w/w, and most preferably at least 80% w/w of the total fat of the butter-like product.

Preferred numbered embodiment 52. The butter-like product to any one of preferred numbered embodiments 47-50 wherein the milk fat intermediate is used in an amount sufficient to provide 50-80% w/w of the total fat of the butter-like product, more preferably at least 21-50% w/w, even more preferably 50-70% w/w, and most preferably 50-60% w/w of the total fat of the butter-like product.

Preferred numbered embodiment 53. The butter-like product to any one of preferred numbered embodiments 47-50 wherein the milk fat intermediate is used in an amount sufficient to provide 50-80% w/w of the total fat of the butter-like product, more preferably at least 21-50% w/w, even more preferably 50-70% w/w, and most preferably 50-60% w/w of the total fat of the butter-like product.

Preferred numbered embodiment 54. The butter-like product to any one of preferred numbered embodiments 47-50 wherein the milk fat intermediate is used in an amount sufficient to provide at least 85% w/w of the total fat of the butter-like product, more preferably at least 90% w/w, even more preferably at least 95% w/w, and most preferably at least 99% w/w of the total fat of the butter-like product.

Preferred numbered embodiment 55. The butter-like product to any one of preferred numbered embodiments 47-50 wherein the milk fat intermediate contributes with at least 50% w/w of the butter-like product, more preferably at least 60% w/w, even more preferably at least 70% w/w, and most preferably at least 80% w/w of the butter-like product.

Preferred numbered embodiment 56. The butter-like product to any one of preferred numbered embodiments 47-50 wherein the milk fat intermediate contributes with 50-80% w/w of the but-ter-like product, more preferably at least 50-75% w/w, even more preferably 50-70% w/w, and most preferably 50-60% w/w of the butter-like product.

Preferred numbered embodiment 57. The butter-like product to any one of preferred numbered embodiments 47-50 wherein the milk fat intermediate contributes with at least 85% w/w of the butter-like product, more preferably at least 90% w/w, even more preferably at least 95% w/w, and most preferably at least 99% w/w of the butter-like product.

Preferred numbered embodiment 58. The butter-like product to any one of preferred numbered embodiments 47-50 wherein the milk fat intermediate contributes with 80-99.5% w/w of the butter-like product, more preferably at least 82-99.0% w/w, even more preferably 84-98% w/w, and most preferably 85-97% w/w of the butter-like product.

Preferred numbered embodiment 59. The butter-like product to any one of preferred numbered embodiments 47-50 wherein the milk fat intermediate obtained from step c) is the butter-like product.

Preferred numbered embodiment 60. Use of the butter-like product according to any one of preferred numbered embodiments 47-59 as an ingredient in the production of a food product, preferably wherein the butter-like product is used in amount to provide at least 5% w/w of the fat of the food product, more preferably at least 10% w/w, even more preferably at least 15% w/w, and most preferably at least 20%.

The present invention has been described above with reference to specific embodiments and aspects. However, other embodiments than the above described are equally possible within the scope of the invention. The different features and steps of various embodiments and aspects of the invention may be combined in other ways than those described herein unless it is stated otherwise.

### EXAMPLES

### Methods of Analysis

### Analysis A: Total Protein

The concentration of protein of a composition was determined by Kjeldahl method (ISO 8968-1:2014/IDF 20) with a conversion factor of 6.25.

### Analysis B: Total Fat and Dry Matter (Total Solids)

The total fat and dry matter contents of a composition was evaluated using MilkoScan™ FT1 (Foss Electric, Hillerod, Denmark) and Smart System 5™ (CEM, Matthews, U.S.A).

### Analysis C: Particle Size Distribution

The particle size distribution of a composition was determined using a Malvern Mastersizer 3000 (Malvern Instruments Ltd., Malvern, UK). The sample was added until an obscuration rate of 10-20% and the refractive indices for milk fat and water were 1.458 and 1.330, respectively. The D[4,3], Dv10, Dv50, and Dv90 values were calculated by the Malvern software and used to interpret the droplet size distribution.

### Analysis D: Microstructure

The microstructure of the cream and concentrated creams was analysed using a Nikon C2 Confocal Laser Scanning Microscope (Nikon Instrument Inc, Tokyo, Japan) with a 100× objective lens. Nile red and Fluorescein isothiocyanate (FITC were used as the fluorescence stain agents for fats and proteins, respectively. Between 5 and 10 pictures were obtained for each sample to get a representative result. The creams after storage at 5 degrees C. were labelled with Nile Red and FITC both dissolved in acetone to a final concentration of 0.001%.

### Analysis E: Firmness

Product firmness was measured at 5 degrees C. on a Texture Analyser (TA XT plus) one week after production. A cone (probe) having a 60 degree angle was pressed 8 mm into the undisturbed product. The trigger force was 5.0 g and the test speed was 49.8 mm per min. As the probe enters the sample, the force increases with the distance and the resistance to deformation by the applied stress is measured. The firmness (measured in gram) of the sample is the value of the maximum force applied to the sample over a specified distance (i.e. 8 mm).

### Analysis F: Proteins in the Permeate Samples

The protein in the permeate samples was dissolved in a reduction buffer by reduction of disulphide bonds (S—S) using DTE and extraction of hydrophobic bonds with urea. 200 μl of sample was added to an eppendorf tube. 1 ml of reduction buffer (100 mM trisodium citrate; 6 M Urea) and 20 μl of 1 M DTE was added. Samples were mixed and incubated for 60 min at 37° C. After incubation, the samples are centrifuged at 13,600×g for 10 min at 5 degrees C. 200 μl of the supernatant was transferred to a vial and analysed using LC-TOF (Agilient Technologies 1290). Parameters used for LC-TOF analysis is listed below.

| System | Agilent Technologies 1290 | |
|---|---|---|
| Method | 190409_poroshell TP_8uPMI.m | |
| Column | Poroshell 120 SB-C18 2.1 × 150 mm 2.7 Micron + | |
| | Guard Column (Agilent) | |
| Column | 40° | C. |
| Temperature | | |
| Mobil phase A | 0.1% TFA in water | |
| Mobil phase B | 0.1% TFA in MeCN | |
| Gradient | 0-34% B from 0-10 min and 34-47% B from | |
| | 10-28 | min |
| Flow | 0.35 | ml/min |
| Injection volume | 8 | μl |
| UV Wavelength | 214 | nm |

| | |
|---|---|
| TOF-Settings | Signal: Positive |
| | Time segment: 2.8-26 min |
| | Signal mode: Profile and Centroid |
| | Mass range: 100-3200 m/z |
| | Gas temperature: 325° C. |
| | Gas flow: 10 l/min |
| | Sheath gas temperature: 300° C. |
| | Sheath gas flow: 7 L/min |
| | Nebulizer pressure: 35 psi |
| | Nozzle energy: 500 V |
| | Vcap: 3500 V |
| | : 200 V |

### Example 1: Preparation of Concentrated Cream with Microfiltration

### Materials and Methods:

### Materials:

Raw milk was heated to 50 degrees C. and separated into cream and skim milk fractions by centrifugation. The cream containing approx. 40% fat was pasteurized (72 degrees C. for 15 seconds) and cooled down to 10 degrees C. for storage for microfiltration experiments.

### Process:

150 kg of pasteurized cream was heated to 55 degrees C. and microfiltered using pilot filtration unit equipped with 7 element ceramic membranes (with nominal pore size of 450 nm, 1020 mm length, 23 channels, 3.5 mm channel diameter, 0.3 m2 surface area/element) until a fat content of 70% was reached. The cream concentrate was diluted to fat content of 62% using RO water and pasteurised (93 degrees C. for 15 seconds) and cooled down to 45 degrees C. The pasteurised concentrated cream was then homogenised using single-stage homogenisation (APV Homogeniser Pilot 4T) at different pressures (0-200 bars).

### Characterisation:

The cream (raw material), the concentrated cream prepared by microfiltration, and homogenised samples were characterised with respect to chemical composition, microstructure and firmness as discussed in the previous section (Methods of Analysis).

### Results:

The composition of the samples before, after concentration by MF and standardisation by RO water is listed below in table 1. The standardised samples with approximately 60-62% (w/w) fat and 3.25% (w/w) proteins were pasteurised and homogenised at different pressure. The casein to whey protein ratio was calculated to be 83:17 where most (assumed to be 100%) of the caseins were in the micellar form. The samples without homogenisation (0 bar) had intact spherical fat globules. At 20 bar, the globule size were slightly smaller and a partial coalescence of fat globules was observed (FIG. 1) while at 40 bar, extensive coalescence of fat globules was observed.

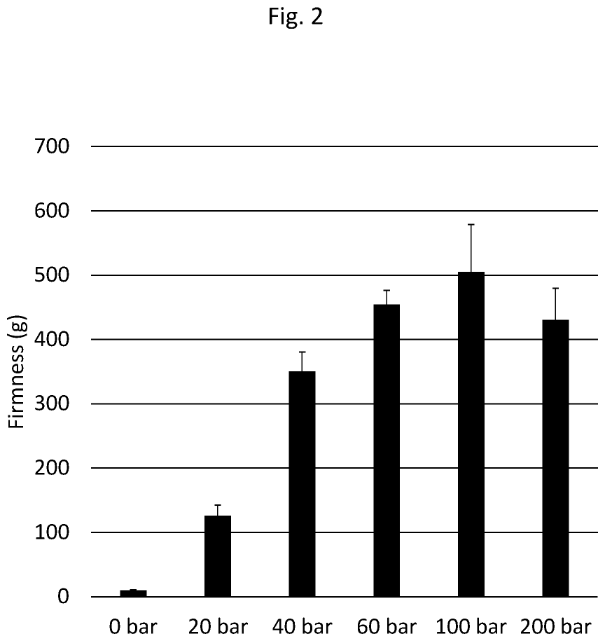

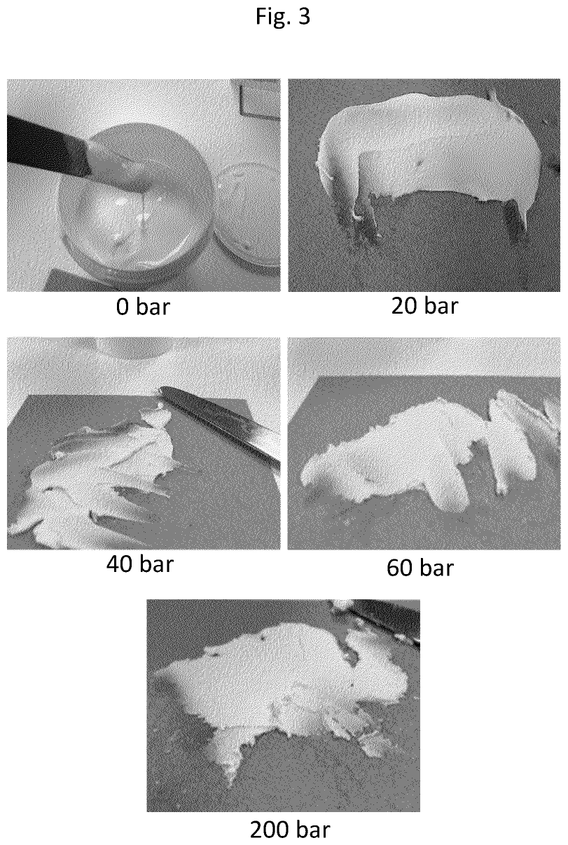

Furthermore, the firmness (FIG. 2) of the homogenised samples after cold storage (5 degrees C.) for at least 7 days showed an interesting functionality (firmness and spreadability). The firmness was found to increase linearly with an increase in homogenisation pressure from 0 to 60 bars. The firmness values reached a plateau at the homogenisation pressure of more than 60 bars. The unhomogenised sample was still in the liquid state while the homogenised samples had butter-like texture which were easily spreadable using butter knife even though the product was perceived harder and gave a bit of gummy texture with increasing the homogenisation pressure as confirmed by the firmness measurement (FIG. 3). Homogenisation process seems to affect the protein-fat interaction giving a surprising effect on structure and functionality.

TABLE 1
Composition of cream before and after concentration
by microfiltration and standardisation with RO water.

| | Composition (%, w/w) | | | |
|---|---|---|---|---|
| | | Protein | | Micellar |
| | | (casein:whey | Dry | casein of |
| Samples | Fat | protein)¹ | matter | total water² |
| Cream before concentration | 37.97 | 2.49 | 44.23 | 3.57 |
| | | (80:20) | | |
| Cream after concentration by MF | 70.22 | 3.81 | 74.58 | 12.44 |
| | | (83:17) | | |
| Standardised cream before | 61.94 | 3.25 | 65.36 | 7.79 |
| homogenization | | (83:17) | | |

¹Casein to whey protein ratio in the final product calculated based on the composition of proteins in the feed before microfiltration and permeate after microfiltration.
²Calculated assuming that nearly 100% of the casein is in micellar form at 45 degrees C.

### Example 2: Preparation of Concentrated Cream by Microfiltration and Diafiltration

In the experiment, the inventors prepared samples of concentrated cream by microfiltration followed by diafiltration with RO water.

### Materials and Methods:

### Materials:

Raw milk was heated to 50 degrees C. and separated into cream and skim milk fractions by centrifugation. The cream containing approx. 40% fat was pasteurized (72 degrees C. for 15 seconds) and cooled down to 10 degrees C. for storage for microfiltration experiments.

### Process:

80 kg of pasteurized cream was heated to 55 degrees C. and microfiltered using pilot filtration unit equipped with 7 element ceramic membranes (with nominal pore size of 450 nm, 1020 mm length, 23 channels, 3.5 mm channel diameter, 0.3 m2 surface area/element). Diafiltration was carried out by adding RO water which was about 3 times of the volume of the retentate (concentrated cream) and concentrated until the fat content reached 67-68%. The concentrate was diluted to fat content of approximately 60% using RO water and pasteurised (93 degrees C. for 15 seconds) and cooled down to 45 degrees C. The pasteurised concentrated cream was then homogenised using single-stage homogenisation (APV Homogeniser Pilot 4T) at different pressures (0-200 bars).

### Characterisation:

The cream (raw material), the concentrated cream prepared by microfiltration and diafiltration, the microfiltration permeate were characterised with respect to chemical composition, microstructure and firmness as discussed in the previous section (Methods of Analysis).

### Results:

The composition of the samples before and after concentration by MF and standardisation by RO water is listed in table 2. The standardised samples with approximately 58-60% (w/w) fat and 2.23% (w/w) proteins were pasteurised and homogenised at different pressures. The samples without homogenisation (0 bar) had intact and spherical fat globules (FIG. 4). For the samples treated at 20 bar, the size of fat globules were slightly smaller and a partial coalescence of fat globules were observed and samples treated at pressure 40 bar or above, extensive coalescence of fat globules were observed.

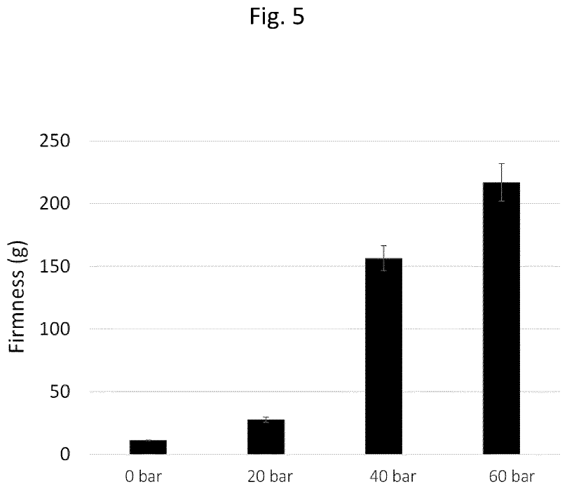

Furthermore, the firmness (FIG. 5) of the homogenised samples after cold storage (5 degrees C.) for at least 7 days showed an interesting functionality (firmness and spreadability) similar to that of example 1. The firmness increased linearly with an increase in homogenisation pressure from 0 to 60 bars. The unhomogenised sample remained in the liquid state while the homogenised samples had butter-like texture which were easily spreadable. Even though the texture was acceptable in terms of spreadability, the samples had lower firmness compared to the samples from the example 1. The reduced values firmness of these samples are correlated with the lower content of micellar casein in the sample. Homogenisation process seems to affect the pro-tein-fat interaction giving a surprising effect on structure and functionality. Homogenisation (mechanical shear) damages milk fat globule membrane so the proteins, especially caseins, are adsorbed on the surface. In addition, with the decrease in the fat globule size due to homogenization, the micellar caseins could act as inert fillers thus increasing the viscosity.

The permeate samples during microfiltration contained only a small amount of proteins i.e. 0.32% (w/v) during microfiltration and 0.16% (w/v) during diafiltration. In addition, the majority of proteins present in the permeate were whey proteins. It means that, most of the micellar caseins were present in the concentrate (concentrated cream). Therefore the surprising product functionality observed could most probably be due to the structure development through micellar casein-fat interactions.

TABLE 2
Composition of cream before and after concentration by
microfiltration, diafiltration and standardization.

| | Composition (%, w/w) | | | |
|---|---|---|---|---|
| | | Protein | | Micellar |
| | | (casein:whey | Dry | casein of |
| Samples | Fat | protein)¹ | matter | total water² |
| Cream before concentration | 37.60 | 2.41 | 43.46 | 3.41 |
| | | (80:20) | | |
| Cream after concentration by MF | 66.99 | 3.51 | 71.94 | 10.51 |
| | | (84:16) | | |
| Standardised cream before | 58.71 | 2.23 | 60.99 | 4.80 |
| homogenization | | (84:16) | | |

¹Casein to whey protein ratio in the final product calculated based on the composition of proteins in the feed before microfiltration and permeate after microfiltration.
²Calculated assuming that nearly 100% of the casein is in micellar form at 45 degrees C.

### Example 3: Preparation of Concentrated Cream by Microfiltration and Diafiltration from Cream (Feed) Treated with Sodium Citrate

In the experiment, the inventors prepared samples of concentrated cream by microfiltration of the cream that was treated with sodium citrate followed by diafiltration with RO water. Sodium citrate was added to the cream prior to filtration to disintegrate the casein micelles into individual proteins. This experiment was conducted to determine the role of micellar caseins on the formation of structure during homogenisation.

### Materials and Methods:

### Materials:

Raw milk was heated to 50 degrees C. and separated into cream and skim milk fractions by centrifugation. The cream containing approx. 40% fat was pasteurized (72 degrees C. for 15 seconds) and cooled down to 10 degrees C. for storage for washing and microfiltration experiments.

### Process:

80 kg of pasteurized cream was treated with sodium citrate (0.77% w/w) overnight. Next day, the cream was microfiltered using pilot filtration unit equipped with 7 element ceramic membranes (with nominal pore size of 450 nm, 1020 mm length, 23 channels, 3.5 mm channel diameter, 0.3 m2 surface area/element). Prior to the filtration experiment, the cream was heated to approximately 55 degrees C. and concentrated by filtration. Diafiltration was carried out by adding RO water which was about 3 times of the volume of the retentate (concentrated cream) and concentrated until the fat content of reached to 64-68%. The concentrate was diluted to fat content of approximately 60% using RO water, pasteurised (93 degrees C. for 15 seconds) and cooled down to 45 degrees C. The pasteurised concentrated cream was then homogenised using single-stage homogenisation (APV Homogeniser Pilot 4T) at different pressures (0-60 bars).

### Characterisation:

The cream (raw material), the concentrated cream prepared by microfiltration & diafiltration, and homogenised samples were characterised with respect to chemical composition, microstructure and firmness as discussed in the previous section (Methods of Analysis).

### Results:

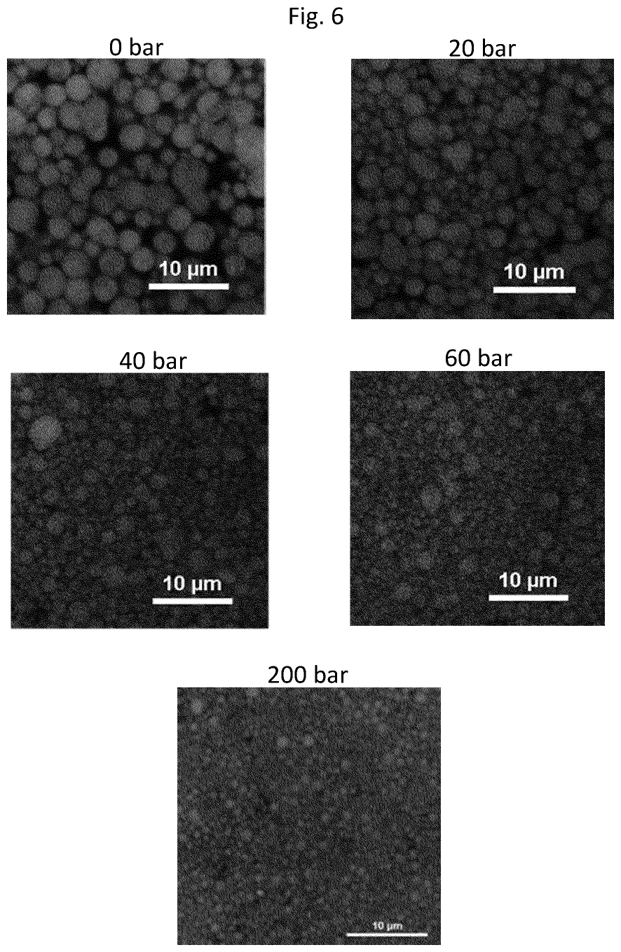

The composition of the samples before and after concentration by microfiltration and standardisation by RO water is listed in table 3. The standardised samples had approximately 63% (w/w) fat and 2.91% (w/w) proteins and were pasteurised and homogenised at different pressure. As shown by the confocal micrographs (FIG. 6), the size of the fat globules decreased with the increase in the homogenisation pressure. Unlike in the examples 1 and 2, no coalescence of fat globules were observed.

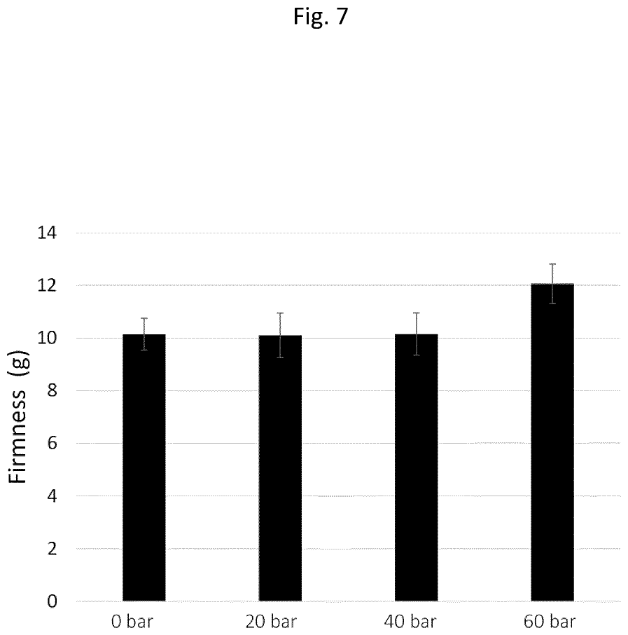

In addition, the product after homogenisation remained quite stable and in soft (liquid) state after cooling to 5 degrees C. The firmness (FIG. 7) was also very low, comparable to the samples without homogenisation in examples 1 and 2, and did not increase with increase in the homogenisation pressure. From this results, it could be concluded that the individual casein proteins formed as a result of adding sodium citrate act more as a emulsifying agent covering and stabilising small fat globules formed by the homogenisation process. In other experiments with similar conditions the homogenisation pressure was increased up to 200 bars, and no visible difference in terms of texture, viscosity and microstructure was observed.

During microfiltration process, the permeate contained slightly higher concentration of proteins i.e. 0.44% (w/v) during microfiltration and 0.25% (w/v) during diafiltration. The higher concentration in the permeate is due to the presence of more caseins. Some of the individual caseins generated due to the addition of sodium citrate could permeate through the membrane (observed by chromatographic analysis of the permeate).

TABLE 3
Composition of cream before and after concentration by microfiltration
and diafiltration and standardization. The feed cream was treated
with sodium citrate before microfiltration.

| | Composition (%, w/w) | | | |
|---|---|---|---|---|
| | | Protein | | Micellar |
| | | (casein:whey | Dry | casein of |
| Samples | Fat | protein)¹ | matter | total water² |
| Cream before concentration | 39.81 | 2.48 | 45.88 | 3.67 |
| | | (80:20) | | |
| Cream after concentration by MF | 65.77 | 2.94 | 69.76 | Low ³ |
| | | (93:7) | | |
| Standardised cream before | 63.36 | 2.91 | 65.68 | Low ³ |
| homogenization | | (93:7) | | |

¹Casein to whey protein ratio in the final product calculated based on the composition of proteins in the feed before microfiltration and permeate after microfiltration.
²Calculated assuming that nearly 100% of the casein is in micellar form at 45 degrees C.
³ The precise content of micellar casein was not determined but must have been very low due to the addition of sodium citrate in amounts known to disintegrate micellar casein.

### Example 4: Preparation of Concentrated Cream by Microfiltration from Washed Cream

In the experiment, the inventors prepared samples of concentrated cream by microfiltration of pre-washed cream to reduce the level of micellar caseins in the final product. The cream (containing 38% fat) was mixed with RO water (9 times the volume of cream) and the fat phase separated by centrifugation. The washed cream was concentrated by microfiltration and standardised to lower the fat content and increase the protein level with sodium caseinate and whey protein isolate. To standardise fat content, 1) 7 kg of RO water was added to 30 kg of concentrated cream; 2) 7 kg of sodium caseinate solution (8.7% protein concentration) was added to 30 Kg of concentrated cream; and 3) 7 kg of whey protein solution (2.2% protein concentration) was added to 30 kg of concentrated cream. This experiment was conducted to determine the role of individual casein and whey proteins on the formation of structure during homogenisation.

### Materials and Methods:

### Materials:

Raw milk was heated to 50 degrees C. and separated into cream and skim milk fractions by centrifugation. The cream containing approx. 40% fat was pasteurized (72 degrees C. for 15 seconds) and cooled down to 10 degrees C. for storage for microfiltration experiments. 4050 kg of RO water was added to 450 kg of cream and cream was separated again by centrifugation.

### Process:

200 Kg of pasteurized washed-cream was microfiltered using pilot filtration unit equipped with 7 element ceramic membranes (with nominal pore size of 450 nm, 1020 mm length, 23 channels, 3.5 mm channel diameter, 0.3 m2 surface area/element). Prior to the filtration experiment, the cream was heated to approximately 55 degrees C. and concentrated by filtration. Three different samples were prepared, 1) concentrate was diluted to fat content of approximately 60% using RO water, 2) concentrate was standardised to fat content of approximately 60% fat using RO water and sodium caseinate solution, and 3) and concentrate was standardised to fat content of approximately 60% fat using RO water and whey protein solution. All the samples were pasteurised (93 degrees C. for 15 seconds) and cooled down to 45 degrees C. The pasteurised concentrated cream was then homogenised using single-stage homogenisation (APV Homogeniser Pilot 4T) at different pressures (0-150 bars).

### Characterisation:

The cream (raw material), washed cream, concentrated cream prepared by microfiltration and homogenised samples were characterised with respect to chemical composition, microstructure and firmness as discussed in the previous section (Methods of Analysis).

### Results:

The composition of the samples before and after washing, concentration by microfiltration and standardisation by RO water is listed in table 4. The washing step decreased the protein level quite significantly to 0.3% (w/w). The fat content of the standardised samples before pasteurisation and homogenisation was between 59 to 60%. The protein content of the standardised sample was 0.38% (w/w) which was then increased to 1.88% by sodium caseinate addition and to 0.66% by adding whey protein isolate solution.

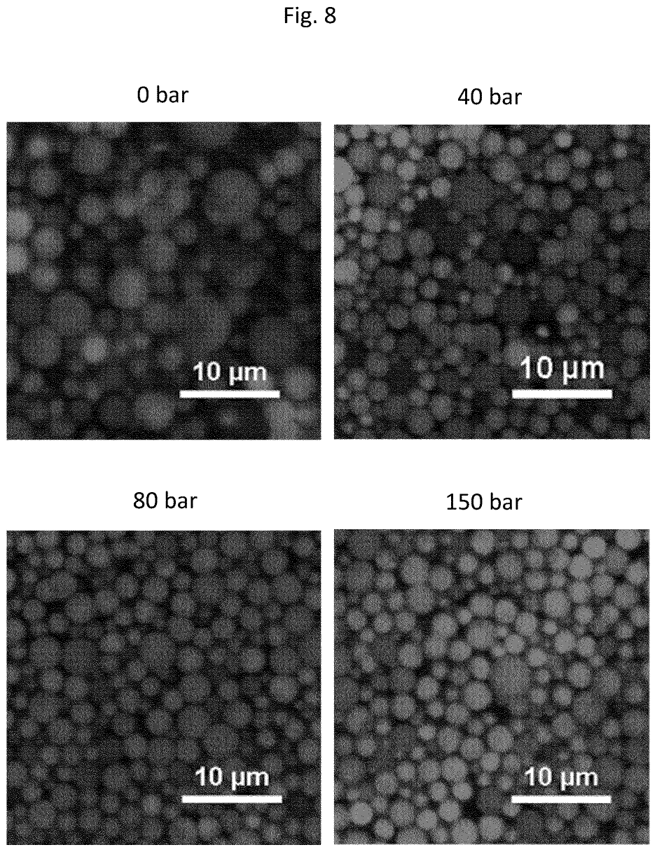

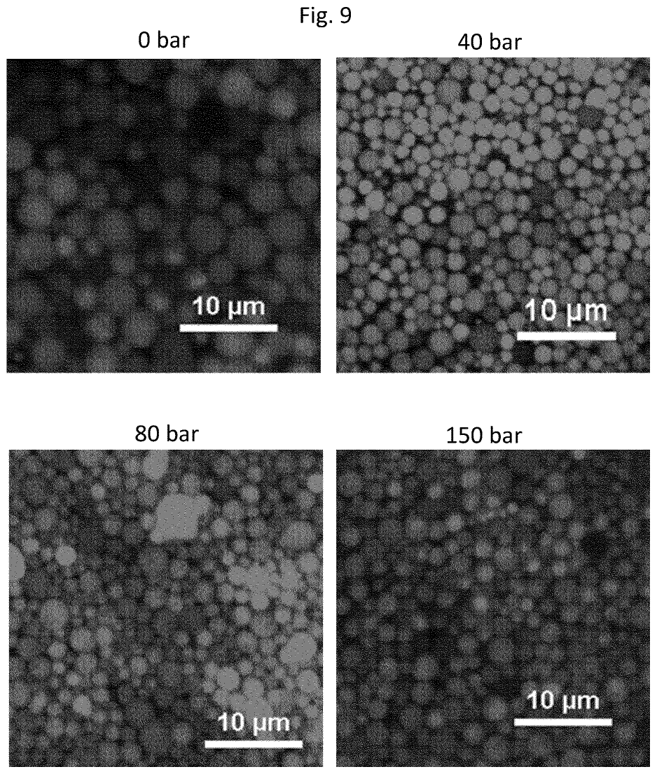

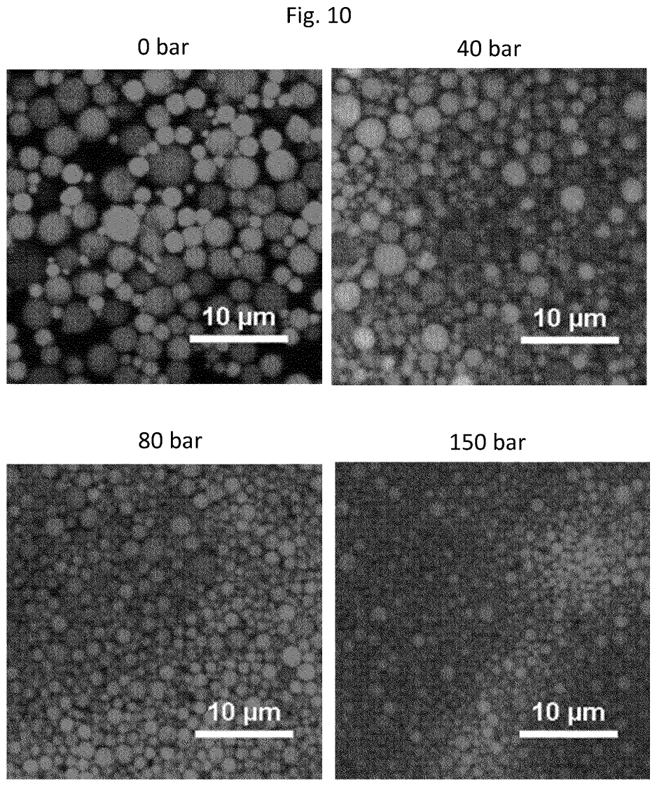

The confocal micrographs (FIG. 8) of the homogenised samples without added proteins slightly smaller sized fat globules after homogenisation (40 bar). Above 40 bars, there was no visible effect of homogenisation on the size of the fat globules. The homogenised samples with added whey proteins had fat globules slightly smaller than without proteins (FIG. 9). Again, the effect of the increase in homogenisation pressure was not visible as the fat globule size remained more or less same from 40 to 150 bars. The fat globule structure of the unhomogenised samples (0 bar) in all three samples were comparable. The confocal micrographs (FIG. 10) for the samples with added sodium caseinate showed quite an interesting result. The size of fat globules decreased as a function of increasing the homogenisation pressure from 0 to 150 bars and no coalescence of fat globules was observed.

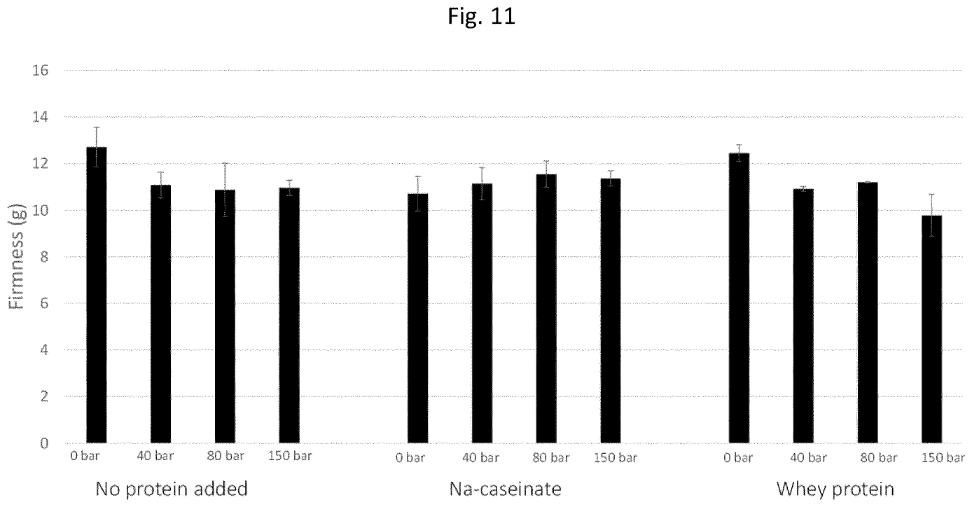

The product properties (texture, firmness and viscosity) of all the samples were however similar to those of samples without added proteins. All the products were soft, creamy and remained in liquid state after cooling and storage at 5 degrees C. No effect of increasing the homogenisation pressure was observed. This was also corroborated by the results from the firmness analysis (FIG. 11) which showed lower firmness values similar to the results from example 3.

TABLE 4
Composition of cream before and after washing, before and after concentration
by microfiltration and diafiltration, and standardization.

| | Composition (%, w/w) | | | |
|---|---|---|---|---|
| | | Protein | | Micellar |
| | | (casein:whey | Dry | casein of |
| Samples | Fat | protein)¹ | matter | total water² |
| Cream before washing | 38.01 | 2.20 | 44.05 | 3.15 |
| | | (80:20) | | |
| Cream after washing | 37.70 | 0.3 | 37.7 | 0.39 |
| | | (80:20) | | |
| Cream after concentration by MF | 74.33 | 0.54 | 74.76 | 1.78 |
| | | (83:17) | | |
| Standardised cream before | 60.08 | 0.38 | 60.78 | 0.80 |
| homogenization | | (83:17) | | |
| Standardised cream with added | 59.99 | 1.88 | 60.53 | 0.80 |
| Na-caseinate | | (97:3) | | |
| Standardised cream with added | 59.24 | 0.66 | 60.15 | 0.79 |
| whey protein | | (52:48) | | |

¹Casein to whey protein ratio in the final product calculated based on the composition of proteins in the feed before microfiltration and permeate after microfiltration.
²Calculated assuming that nearly 100% of the casein is in micellar form at 45 degrees C.

### Example 5: Preparation of Butter-Like Product Using Concentrated Cream by Microfiltration and Further Ingredients

Twelve samples of butter-like products of the invention are prepared using a standardised concentrated cream (the MFG source; 60% w/w fat; prepared according to Example 1), salt, cultured milk, and rapeseed oil (in some of the samples). The standardised concentrated cream is pasteurised and subsequently mixed with salt, lactic culture, different levels of vegetable oil to prepare liquid milk fat globule composition (lmc) before or after homogenisation steps. The lmc composition is homogenised at different pressures (40 or 80 bar) to modulate the texture (firmness) of the final butter-like product. After the mixing and homogenisation the obtained samples of butter-like product are cooled to 5 degrees C. The used recipes and selected characteristics of the samples of butter-like product are shown in Table 5.

TABLE 5
Recipes of the samples of butter-like product (BLP) and selected characteristics.

| | BLP-1 | BLP-2 | BLP-3 | BLP-4 | BLP-5 | BLP-6 |
|---|---|---|---|---|---|---|
| Ingredients | | | | | | |
| Standardised | 96 | 91 | 86 | 96 | 91 | 86 |
| concentrated cream | | | | | | |
| Salt (% w/w) | 1.2 | 1.2 | 1.2 | 1.2 | 1.2 | 1.2 |
| Cultured milk (% | 2.8 | 2.8 | 2.8 | 2.8 | 2.8 | 2.8 |
| w/w) | | | | | | |
| Rapeseed oil (% | 0 | 5 | 10 | 0 | 5 | 10 |
| w/w) | | | | | | |
| Characteristics | | | | | | |
| Water content in the | 33 | 31 | 29 | 33 | 31 | 29 |
| final product (% | | | | | | |
| w/w) | | | | | | |
| pH | 5.2 | 5.2 | 5.2 | 5.2 | 5.2 | 5.2 |
| Pressure-difference | 40 | 40 | 40 | 80 | 80 | 80 |
| during homogenisation | | | | | | |
| Addition of vegetable | Prior to | Prior to | Prior to | Prior to | Prior to | Prior to |
| oil, cultured milk and | homogenisation | homogenisation | homogenisation | homogenisation | homogenisation | homogenisation |
| salt | | | | | | |
| | BLP-7 | BLP-8 | BLP-9 | BLP-10 | BLP-11 | BLP-12 |
| Ingredients | | | | | | |
| Standardised | 96 | 91 | 86 | 96 | 91 | 86 |
| concentrated cream | | | | | | |
| Salt (% w/w) | 1.2 | 1.2 | 1.2 | 1.2 | 1.2 | 1.2 |
| Cultured milk (% | 2.8 | 2.8 | 2.8 | 2.8 | 2.8 | 2.8 |
| w/w) | | | | | | |
| Rapeseed oil (% | 0 | 5 | 10 | 0 | 5 | 10 |
| w/w) | | | | | | |
| Characteristics | | | | | | |
| Water content in the | 33 | 31 | 29 | 33 | 31 | 29 |
| final product (% | | | | | | |
| w/w) | | | | | | |
| pH | 5.2 | 5.2 | 5.2 | 5.2 | 5.2 | 5.2 |
| Pressure-difference | 40 | 40 | 40 | 80 | 80 | 80 |
| during homogenisation | | | | | | |
| Addition of vegetable | After the | After the | After the | After the | After the | After the |
| oil, cultured milk and | homogenisation | homogenisation | homogenisation | homogenisation | homogenisation | homogenisation |
| salt | | | | | | |

### Conclusions:

In the present examples, the inventors have found that concentrated cream with intact fat globules produced by gentle microfiltration, which causes minimum damage to milk fat globules, can be used to make butter-like spreadable products. After microfiltration, the concentrated cream containing mainly micellar casein and some whey proteins is standardised to a desired fat level (for example to 60%, w/w), pasteurised, homogenised (mechanical shear treatment) at warm temperature (45 degrees C.), packaged and stored at 5 degrees C. The obtained product has unique and surprising properties like butter and spreads in terms of structure and functionality (texture, spreadability). Such a product could be made using a simple yet fast continuous process compared to conventional methods of butter making that involves cream aging and treatments like churning. The present method furthermore has the benefit that is does not give rise to the formation of butter-milk during the butter-making process.

The experiments reported in the present examples showed that micellar casein plays a significant role in the structure formation. In the presence of micellar casein (naturally present in the cream or added) homogenisation could increase the firmness of the product but not in its absence. However, replacement of casein micelles by non-micellar caseinates or addition of a sub-stance that disintegrate micellar caseins to individual casein proteins such as sodium citrate prior to mechanical shear (e.g. homogenisation) does not increase the firmness but produces a stable liquid cream product even at high fat concentration (60% w/w).

1. A method of producing a butter-like product, the method comprising the steps of:
a) providing a liquid, milk fat globule composition (lmc), preferably having a temperature in the range of 20-65 degrees C. and a pH in the range of 4.5-8, the lmc comprising:
i) milk fat globules (MFG) in an amount of at least 50% w/w of the lmc,
ii) at least 1.5% w/w micellar casein relative to the weight of the water content of the lmc,
iii) water, and
iv) optionally, one or more additional component(s),
b) optionally, but preferably, subjecting the lmc to a heat-treatment in which the lmc is heated to a temperature of at least 66 degrees C.,
c) subjecting the lmc obtained from step a) or b) to a shearing step, and wherein the temperature of the lmc during the shearing step is in the range of 25-100 degrees C., thereby obtaining a milk fat intermediate,
d) optionally, combining the milk fat intermediate and one or more further ingredient(s), thereby obtaining a mixture, and
e) optionally, packaging the milk fat intermediate obtained from step c) or the mixture obtained from step d),
wherein the MFG originate from cow milk,
and wherein the butter-like product is the milk fat intermediate obtained from step c), the mixture obtained from step d), or the packaged product obtained from step e).

2. The method according to claim 1 wherein at least 50% w/w of the MFG of the lmc is provided by one or more MFG source(s) containing MFG in an amount of at least 50% w/w relative to the weight of the source, preferably prepared by microfiltration and/or centrifugation of milk, cream, or mixtures thereof.

3. The method according to any one of the preceding claims wherein the lmc comprises the one or more additional ingredient(s) which comprise one or more of the following:
water
fermented milk product
sodium chloride,
a flavouring agent, preferably diacetyl,
a colouring agent,
a food acceptable preservative, preferably sodium sorbate,
a polysaccharide hydrocolloid,
a protein concentrate, preferably a whey protein concentrate, a concentrate of micellar casein, and/or a milk protein concentrate,
a fat source, preferably vegetable fat and/or butter,
a food acceptable antioxidant, and
a vitamin.

4. The method according to any one of the preceding claims wherein the lmc comprises:
MFG in an amount in the range of 50-85% w/w, more preferably in the range of 55-85% w/w, and most preferably in the range of 50-82% w/w, and/or
water in the range of 10-49% w/w relative to total weight of the lmc, more preferably 10-44% w/w, and most preferably in the range of 10-39% w/w relative to total weight of the lmc.

5. The method according to any one of the preceding claims wherein the lmc comprises:
MFG in an amount in the range of 50-70% w/w, more preferably in the range of 55-68% w/w, and most preferably in the range of 55-65% w/w, and/or
water in the range of 15-49% w/w relative to total weight of the lmc, more preferably 20-44% w/w, and most preferably in the range of 25-44% w/w relative to total weight of the lmc.

6. The method according to any one of the preceding claims wherein the lmc comprises micellar casein in an amount in the range of 1.5-15% w/w relative to the water content of the lmc, more preferably 2-13% w/w, even more preferably 3-11% w/w, and most preferably in the range of 4-9% w/w relative to the water content of the lmc.

7. The method according to any one of the preceding claims wherein whey protein makes up at least 50% w/w of the protein of the lmc that is not micellar casein, more preferably at least 60% w/w, even more preferably at least 70% w/w and most preferably at least 80% w/w of the protein of the lmc that is not micellar casein.

8. The method according to any one of the preceding claims wherein the lmc comprises, or even consists of:
MFG source having a MFG content in the range of 55-65% w/w in an amount of 85-96% w/w of the lmc
Sodium chloride in an amount of 0.2-2% w/w of the lmc
Fermented milk in an amount of 1-4% w/w of the lmc
Vegetable fat in an amount of 0-10% w/w of the lmc.

9. The method according to any one of the preceding claims wherein the lmc of step a) has a temperature in the range of 20-65 degrees C., more preferably 30-64 degrees C., even more preferably 40-63 degrees C., and most preferably 50-62 degrees C.

10. The method according to any one of the preceding claims wherein the shearing of step c) is performed using a pressure-based homogenizer and/or a mechanical homogenizer.

11. The method according to any one of the preceding claims wherein the duration of the shearing of step c) is sufficient to create a milk fat intermediate having a firmness in the range of 25-500 g at 5 degrees C. when determined according to Analysis E, more preferably 50-450 g at 5 degrees C., even more preferably 100-400 g at 5 degrees C., and most preferably 200-400 g at 5 degrees C.

12. The method according to any one of the preceding claims wherein the temperature of the lmc during the shearing is:
in the range of 25-100 degrees C., more preferably 30-95 degrees C., even more preferably 40-80 degrees C., and most preferably 50-65 degrees C., or
in the range of 70-100 degrees C., more preferably 75-98 degrees C., even more preferably 80-96 degrees C., and most preferably 85-95 degrees C.

13. The method according to any of the preceding claims wherein the shearing of step c) involves the use of a pressure-based homogenizer, preferably operated with a pressure difference in the range of 5-300 bar, more preferably 10-200 bar, even more preferably 15-150 bar and most preferably 20-100 bar.

14. The method according to any one of the preceding claims comprising step d) of combining the milk fat intermediate and one or more further ingredient(s), and wherein the one or more further ingredient(s) comprise one or more of:
water
fermented milk product, preferably added in an amount in the range of 1-5% w/w relative to the weight of the mixture, more preferably 1.2-4%, and most preferably in the range of 1.5-3% w/w relative to the weight of the mixture,
sodium chloride, preferably added in an amount in the range of 0.1-4.5% w/w relative to the weight of the mixture, more preferably 0.5-3.0% w/w, and most preferably 0.8-1.5% w/w relative to the weight of the mixture,
a flavouring agent, preferably diacetyl,
a colouring agent,
a food acceptable preservative, preferably sodium sorbate,
a polysaccharide hydrocolloid,
a protein concentrate, preferably a whey protein concentrate, a concentrate of micellar casein, and/or a milk protein concentrate,
a fat source, preferably vegetable fat and/or butter,
a food acceptable antioxidant, and
a vitamin, and
wherein:
the milk fat intermediate is used in step d) in an amount sufficient to contribute with at least 50% w/w of the total fat of the mixture resulting from step d), more preferably at least 60% w/w, more preferably at least 70% w/w, and most preferably at least 80% w/w of the mixture resulting from step d), or
the milk fat intermediate is used in step d) in an amount sufficient to contribute with 40-99% w/w of the total fat of the mixture resulting from step d), more preferably 45-90 w/w, more preferably 50-80% w/w, and most preferably 52-70% w/w of the mixture resulting from step d.

15. The butter-like product obtainable by the method according to one or more of claims 1-14, wherein the milk fat intermediate obtained from step c) is used in an amount sufficient to provide at least 50% w/w of the total fat of the butter-like product.

16. The butter-like product according to claim 15 having a pH in the range of 4.5-8, more preferably 5.5-7.7, and most preferably 6.0-7.5.

17. The butter-like product according to claim 15 having a pH in the range of 4.5-6, more preferably 4.6-5.8, and most preferably 5.0-5.5.

18. The butter-like product according to any one of claims 15-17 comprising:
total fat in an amount in the range of 50-85% w/w, and preferably in the range of 60-85% w/w,
water in an amount in the range of 10-48% w/w, and preferably in the range of 10-39% w/w
total protein in an amount in the range of 0.1-5% w/w,
and preferably having a pH in the range of 4.5-7.5.

19. The butter-like product according to any one of claims 15-18 wherein the milk fat intermediate is used in an amount sufficient to provide at least 60% w/w, even more preferably at least 70% w/w, and most preferably at least 80% w/w of the total fat of the butter-like product.

20. The butter-like product according to any one of claims 15-19 wherein the milk fat intermediate is used in an amount sufficient to provide 50-80% w/w of the total fat of the butter-like product, more preferably 50-70% w/w, and most preferably 50-60% w/w of the total fat of the butter-like product.

21. The butter-like product according to any one of claims 15-19 wherein the milk fat intermediate is used in an amount sufficient to provide at least 85% w/w of the total fat of the butter-like product, more preferably at least 90% w/w, even more preferably at least 95% w/w, and most preferably at least 99% w/w of the total fat of the butter-like product.

22. The butter-like product according to any one of claims 15-21 wherein the milk fat intermediate contributes with at least 50% w/w of the butter-like product, more preferably at least 60% w/w, even more preferably at least 70% w/w, and most preferably at least 80% w/w of the butter-like product.

23. The butter-like product according to any one of claims 15-22 wherein the milk fat intermediate contributes with 50-80% w/w of the butter-like product, more preferably at least 50-75% w/w, even more preferably 50-70% w/w, and most preferably 50-60% w/w of the butter-like product.

24. The butter-like product according to any one of claims 15-22 wherein the milk fat intermediate contributes with at least 85% w/w of the butter-like product, more preferably at least 90% w/w, even more preferably at least 95% w/w, and most preferably at least 99% w/w of the butter-like product.

25. The butter-like product according to any one of claims 15-22 wherein the milk fat intermediate contributes with 80-99.5% w/w of the butter-like product, more preferably at least 82-99.0% w/w, even more preferably 84-98% w/w, and most preferably 85-97% w/w of the butter-like product.

26. The butter-like product according to any one of claims 15-25 wherein the milk fat intermediate obtained from step c) is the butter-like product.

27. Use of the butter-like product according to one or more of claims 15-26 as an ingredient in the production of a food product, preferably wherein the butter-like product is used in amount to provide at least 5% w/w of the fat of the food product, more preferably at least 10% w/w, even more preferably at least 15% w/w, and most preferably at least 20%.
